(19) United States
(12) Patent Application Publication
(10) Pub. No.: US 2005/0131192 A1
(43) Pub. Date: Jun. 16, 2005

(54) Polymer and process for producing polymer

(76) Inventors: Takehisa Matsuda, Osaka (JP); Tetsuo Itoh, Kyoto-shi (JP); Tatsuya Ohsumi, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/499,331

(22) PCT Filed: Oct. 30, 2002
(86) PCT No.: PCT/JP02/11291

(30) Foreign Application Priority Data
Dec. 18, 2001 (JP) 2001-384099
Apr. 23, 2002 (JP) 2002-121259
Apr. 24, 2002 (JP) 2002-121820
May 26, 2002 (JP) 2002-127117

(51) Int. Cl. C08G 18/00

(52) U.S. Cl. 528/44

(57) ABSTRACT

The object of the present invention is to provide a polymer best suited for use as a medical adhesive excellent in wet adhesion strength (water-resistant adhesive strength). In the present invention, a polymer capable of forming a cured film and useful as a medical adhesive, which has a viscosity at 37° C. of 0.5 to 2,000 Pa·s and shows a saturated water absorption of 0.2 to 5 ml/g, is used. The above-mentioned polymer preferably shows an initial water absorption rate of 0.01 to 0.5 ml/g·min, the wet elongation percentage of the cured film is preferably 100 to 1,500%, and the wet 100% modulus of the cured film is preferably 0.01 to 10 MPa. Additionally, it is preferable that the above-mentioned polymer contains oxyethylene groups and in which the oxyethylene group content is 30 to 100% by weight based on the weight of the polymer.

### TECHNICAL FIELD

The present invention relates to a polymer and a process for producing polymers. More particularly, it relates to a polymer best suited for use as a medical adhesive excellent in water-resistant adhesive strength which is effective in adhesion of wet vital organs such as lung, artery and heart, in particular, and to a process for producing such a polymer.

### BACKGROUND ART

Hydrophilic urethane prepolymers obtainable by reacting a fluorine-containing polyisocyanate with a hydrophilic polyether polyol are known in the art as medical adhesives (Japanese Kokai Publication Hei-01-227762).

However, such prior art medical adhesives have problems; namely, heterogeneous reactions may occur due to the high reactivity between the fluorine-containing isocyanate component and hydrophilic polyether polyol, resulting in abnormal increases in viscosity during prepolymer preparation, heterogeneity in prepolymer, and fluctuations in adhesive strength. Furthermore, there is a problem that such prepolymers have low wet adhesive strength.

### SUMMARY OF THE INVENTION

Thus, it is an object of the present invention to provide a polymer best suited for use as a medical adhesive excellent in wet adhesion strength (water-resistant adhesive strength).

The present inventors made intensive investigations in an attempt to accomplish the above object and found that when a polymer having a specific level of viscosity and a specific initial water absorption rate is used, a medical adhesive excellent in wet adhesion strength can be obtained. This and further findings have now led to completion of the present invention.

Thus, the polymer of the invention is characterized in that it is

a polymer capable of forming a cured film and useful as a medical adhesive,

which has a viscosity at 37° C. of 0.5 to 2,000 Pa·s and shows a saturated water absorption of 0.2 to 5 ml/g.

### DETAILED DESCRIPTION OF THE INVENTION

The viscosity (in Pa·s) at 37° C. of the polymer of the invention is preferably not lower than 0.5, more preferably not lower than 1, particularly preferably not lower than 3, most preferably not lower than 5, and it is preferably not higher than 2,000, more preferably not higher than 1,000, particularly preferably not higher than 500, most preferably not higher than 50. Within such range, the adhesive applicability tends to become good.

<Polymer Viscosity Measurement Method>

Viscosity measurements are made using a DA viscometer according to the method D described in the “Method of testing for viscosity of liquid resins using a rotational viscometer” prescribed in JIS K 7117-1987. Useful as the rotational viscometer is Tokimec INC's model BH viscometer and the like.

The saturated water absorption (in ml/g) of the polymer of the invention is preferably not smaller than 0.2, more preferably not smaller than 0.3, particularly preferably not smaller than 0.4, most preferably not smaller than 0.5, and preferably not larger than 5, more preferably not larger than 3, particularly preferably not larger than 1, most preferably not larger than 0.7. Within such range, the adhesive strength (in particular initial adhesive strength) tends to become higher.

<Saturated Water Absorption Measurement Method>

Using-an apparatus for D/W method of testing for water absorption rates (buret capacity: 25 ml, length: 55 cm, small opening diameter: 2 mm) as shown in JIS K 7224-1996 “Method of testing for water absorption rates of highly water absorbing resins”—Illustration 1, measurements are carried out in a room at 25° C. and 50% humidity with a filter paper having a diameter of 3.7 cm (e.g. Whatman's glass microfiber filter GF/A, and the like) installed in lieu of the nonwoven fabric, together with a polycarbonate cylinder having an inside diameter of 3.7 cm. First, with each valve closed, 25 ml of a test solution (physiological saline) is placed in the buret and, then, each valve is opened to fill the space from the buret to the valves with the test solution. Then, a rubber stopper is mounted, the valve below the buret is opened, the overflowing test solution is wiped off, and the graduation (al) on the buret is read. Then, 1.0 g of the polymer is added onto the filter paper in the cylinder and a ventil with a diameter of 3.7 cm is pushed into the cylinder for uniform setting of the polymer. After 30 minutes, the graduation (a2) on the buret is read. The value obtained by subtracting (al) from (a2) is recorded as the saturated water absorption (ml/g).

The initial water absorption rate (in ml/g·min) is preferably not lower than 0.01, more preferably not lower than 0.02, particularly preferably not lower than 0.03, most preferably not lower than 0.04, and preferably not higher than 0.5, more preferably not higher than 0.3, particularly preferably not higher than 0.2, most preferably not higher than 0.1. Within such range, the adhesive strength (in particular initial adhesive strength) becomes higher.

<Initial Water Absorption Rate Measurement Method>

In the same manner as in the saturated water absorption measurement, the graduation (a3) on the buret is read at 2 minutes after polymer setting, and one half of the value obtained by subtracting (al) from (a3) is recorded as the initial water absorption rate (ml/g·min).

The cured film of the polymer of the invention preferably has a wet elongation percentage (in %) of not lower than 100, more preferably not lower than 200, particularly preferably not lower than 300, most preferably not lower than 400, and preferably not higher than 1,500, more preferably not higher than 1,200, particularly preferably not higher than 1,000, most preferably not higher than 800. Within such range, the adhesive strength (in particular water-resistant adhesive strength) becomes higher.

Furthermore, the cured film preferably has a wet 100% modulus (in MPa) of not lower than 0.01, more preferably not lower than 0.05, particularly preferably not lower than 0.1, most preferably not lower than 0.4, and preferably not higher than 10, more preferably not higher than 5, particularly preferably not higher than 2, most preferably not higher than 0.7. Within such range, the adhesive strength (in particular water-resistant adhesive strength) becomes higher.

<Measurement Method for Wet Elongation Percentage and Wet 100% Modulus of Cured Films>

Cured film test specimens for wet elongation percentage and wet 100% modulus measurements are prepared by applying the polymer on a glass plate to a size of 10 cm square and a thickness of about 100 μm using an applicator, allowing the coating to stand at 25° C. and 50% RH for 48 hours for attaining curing, allowing the same to stand in a physiological saline bath at 25° C. and, after 24 hours, taking out the same, and stamping specimens out of the same using a No. 3 dumbbell-shaped die described in JIS K 6251-1993. The specimens stamped out are kept in physiological saline for 1 hour, deprived of moisture with gauze, precisely measured for thickness and, within 5 minutes, subjected to measurements for tensile tensions corresponding to elongation at break and 100% elongation at a rate of pulling of 300 mm/min in an atmosphere of 25° C. and 50% RH according to JIS K 6251-1993. Employable as the tensile testing machine is such a testing machine as prescribed in JIS K 6850-1999 (e.g. Shimadzu Corp's model AGS-500B autograph or the like), or the like.

In accordance with the present invention, the polymer capable of forming cured films includes reactive functional group-containing polymers [polyethers, polyesters, polyamides, polyureas, polyurethanes and vinyl polymers (acrylic polymers, polystyrene, polyolefins, polydienes, natural rubbers, etc.)], and the like. As the reactive functional group, there may be mentioned an isocyanato group, epoxy group (e.g. a glycidyl, 2,3-oxacyclohexyl and the like group), (meth)acryloyl group, cyano(meth)acryloyl group, alkoxysilyl group (e.g. trimethoxysilyl, triethoxysilyl and the like group) and the like group, and precursors of these [blocked isocyanato groups (e.g. phenyloxycarbamoyl group) etc.], and the like.

Preferably, the polymer of the invention has a number average molecular weight (Mn) of not lower than 500, more preferably not lower than 800, particularly preferably not lower than 1,000, most preferably not lower than 1,200, but not higher than 500,000, more preferably not higher than 100,000, particularly preferably not higher than 10,000, most preferably not higher than 5,000. Within this range, the adhesive strength (in particular wet adhesive strength) becomes higher. The Mn can be determined by gel permeation chromatography (GPC) using polyethylene glycol species, polystyrene species or the like, as standard substances.

From the adhesive strength (in particular initial adhesive strength) and the like viewpoint, the polymer of the invention is preferably a hydrophilic polymer. The term “hydrophilic polymer” means a polymer having a polyoxyethylene group content of not lower than 30% by weight per molecule or one comparable in affinity for water thereto. The oxyethylene group content (in % by weight) in the polymer as based on the polymer weight is preferably not lower than 30, more preferably not lower than 40, particularly preferably not lower than 45, most preferably not lower than 50, and preferably not higher than 100, more preferably not higher than 90, particularly preferably not higher than 80, most preferably not higher than 75. Within such range, the adhesive strength (in particular initial adhesive strength) of the polymer becomes higher.

From the reactivity and the like viewpoint, the polymer of the invention is preferably an isocyanato group-containing polymer having isocyanato group as a reactive functional group. In cases where the polymer is an isocyanato group-containing one, the isocyanato group content (in % by weight) in the polymer as based on the polymer weight is preferably not lower than 0.1, more preferably not lower than 0.5, particularly preferably not lower than 1, most preferably not lower than 2, and preferably not higher than 20, more preferably not higher than 15, particularly preferably not higher than 10, most preferably not higher than 5. Within such range, the adhesive strength (in particular initial adhesive strength and water-resistant adhesive strength) of the polymer becomes higher. For isocyanato group content determination, the polymer is dissolved in a solution of an excess amine (e.g. dibutylamine or the like) in a solvent (e.g. toluene, dimethylformamide, dimethyl sulfoxide or the like) for reaction with the amine, the unreacted portion of the amine is titrated with hydrochloric acid in methanol, and the thus-obtained number of moles of the isocyanato group per unit weight is multiplied by 42. The product is recorded as the isocyanato group content (% by weight) per unit weight.

The isocyanato group-containing polymer includes urethane prepolymers (UPs) having a structure resulting from the reaction of a polyisocyanate (A) with an active hydrogen-containing polymer (B), non-polyisocyanate-based polymers (NUPs) having a structure resulting from conversion of one or more functional groups in an active hydrogen-containing polymer (B) to isocyanato groups, and the like.

Employable as the polyisocyanate (A) to be used in obtaining the urethane prepolymers (UPs) are aromatic polyisocyanates containing 6 to 19 carbon atoms (excluding the carbon atoms in the NCO groups; hereinafter the same shall apply), aliphatic polyisocyanates containing 1 to 22 carbon atoms, alicyclic polyisocyanates containing 6 to 19 carbon atoms, araliphatic polyisocyanates containing 8 to 16 carbon atoms, modifications thereof, mixtures of two or more of these, and the like.

As the aromatic polyisocyanates, there may be mentioned 1,3- or 1,4-phenylene diisocyanate (PDI), 2,4- or 2,6-tolylene diisocyanate (TDI), crude TDI, 2,4′- or 4,4′-diphenylmethanediisocyanate (MDI), crude MDI, 1,5-naphthalenediisocyanate, 4,4′,4″-triphenylmethanetriisocyanate, m- or p-isocyanatophenylsulfonyl isocyanate, mixtures of these, and the like.

Employable as the aliphatic polyisocyanates are fluorine-free aliphatic polyisocyanates, fluorine-containing aliphatic polyisocyanates and the like.

As the fluorine-free aliphatic polyisocyanates, there may be mentioned methylene diisocyanate, ethylene diisocyanate, tetramethylene diusocyanate, hexamethylene diisocyanate (HDI), dodecamethylene diisocyanate, 1,6,11-undecanetriisocyanate, 2,2,4-trimethylhexamethylene diisocyanate, lysinediisocyanate, 2,6-diisocyanato methyl caproate, bis(2-isocyanatoethyl) fumarate, bis(2-isocyanatoethyl) carbonate, 2-isocyanatoethyl 2,6-diisocyanatohexanoate, mixtures of these, and the like.

As the fluorine-containing aliphatic polyisocyanates, there may be mentioned those represented by OCN—R_{f}—NCO, those represented by OCN—CH₂—R_{f}—CH₂—NCO, those represented by OCN—CF₂—R—CF₂—NCO, those represented by OCN—CH₂—CF₂—R—CF₂—CH₂—NCO, those represented by OCN—CH(CF₃)—R—CH(CF₃)—NCO, mixtures of these, and the like. In the formulas, R_{f} represents a perfluoroalkylene group containing 1 to 20 carbon atoms, which may optionally contain one or more ether bonds, and R represents an alkylene group containing 1 to 18 carbon atoms, which may optionally contain one or more ether bonds.

As those represented by OCN—R_{f}—NCO, there may be mentioned difluoromethylene diisocyanate, perfluorodimethylene diisocyanate, perfluorotrimethylene diisocyanate, perfluoroeicosa diisocyanate, bis(isocyanatoperfluoroethyl) ether, bis(diisocyanatoperfluoroisoproyl) ether, and the like.

As those represented by OCN—CH₂—R_{f}—CH₂—NCO, there may be mentioned bis(isocyanatomethyl)difluoromethane, bis(isocyanatomethyl)perfluoroethane, bis(isocyanatomethyl)perfluoropropane, bis(isocyanatomethyl)perfluorobutane (FHMDI), bis(isocyanatomethyl)perfluoropentane, bis(isocyanatomethyl)perfluorohexane, bis(isocyanatomethyl)perfluoroeicosane, bis(isocyanatomethylperfluoroethyl) ether, and the like.

As those represented by OCN—CF₂—R—CF₂—NCO, there may be mentioned bis(isocyanatodifluoromethyl)methane, bis(isocyanatodifluoromethyl)propane, bis(isocyanatodifluoromethyl)octadecane, 2,2′-bis(isocyanatodifluoromethylethyl) ether, and the like.

As those represented by OCN—CH₂—CF₂—R—CF₂—CH₂—NCO, there may be mentioned bis(2-isocyanato-1,1-difluoroethyl)methane, bis(2-isocyanato-1,1-difluoroethyl)propane, bis(2-isocyanato-1,1-difluoroethyl)hexadecane, bis(2-isocyanato-1,1-difluoroethylethyl) ether, and the like.

As those represented by OCN—CH(CF₃)—R—CH(CF₃)—NCO, there may be mentioned diisocyanato-1,1,1,4,4,4-hexafluoropentane, bis(isocyanato-3,3,3-trifluoropropyl) ether, and the like.

Employable as the alicyclic polyisocyanates are fluorine-free alicyclic polyisocyanates, fluorine-containing alicyclic polyisocyanates and the like.

As the fluorine-free alicyclic polyisocyanates, there may be mentioned isophoronediisocyanate (IPDI), dicyclohexylmethane-4,4′-diisocyanate (hydrogenated MDI), cyclohexylene diisocyanate, methylcyclohexylene diisocyanate (hydrogenated TDI), 4,4′,4″-tricyclohexylmethanetriisocyanate, bis(2-isocyanatoethyl) 4-cyclehexene-1,2-dicarboxylate, 2,5- or 2,6-norbornanediisocyanate, mixture of these, and the like.

As the fluorine-containing alicyclic polyisocyanates, there may be mentioned diisocyanatoperfluorocyclohexane, diisocyanatotetrafluorocyclohexane, bis(isocyanatomethyl)perfluorocyclohexane, bis(isocyanatomethyl)tetrafluorocyclohexane, bis(isocyanatomethyl)perfluorodimethylcyclohexane, bis(isocyanatomethyl)dimethyltetrafluorocyclohexane, bis(isocyanatodifluoromethyl)cyclohexane, bis(isocyanatoperfluorocyclohexyl), bis(isocyanatotetrafluorocyclohexyl), bis(isocyanatoperfluorocyclohexyl)perfluoropropane, bis(isocyanatotetrafluorocyclohexyl)perfluoropropane, bis(isocyanatomethylperfluorocyclohexyl)perfluoropropane, bis(isocyanatomethyltetrafluorocyclohexyl)perfluoropropane, bis(2-isocyanato-1,1-difluoroethyl)cyclohexane, bis(2-isocyanato-1,1-difluoroethyl)cyclohexane, mixtures of these, and the like.

Employable as the araliphatic polyisocyanates are fluorine-free araliphatic polyisocyanates, fluorine-containing araliphatic polyisocyanates, and the like.

As the fluorine-free araliphatic polyisocyanates, there may be mentioned m- or p-xylylene diisocyanate (XDI), α, α, α′, α′-tetramethylxylylene diisocyanate (TMXDI), α, α, α′, α′-tetraethylxylylene diisocyanate (TMXDI), mixtures of these, and the like.

As the fluorine-containing araliphatic polyisocyanates, there may be mentioned bis(isocyanatomethyl)perfluorobenzene, bis(isocyanatomethyl)dimethylperfluorobenzene, bis(isocyanatoperfluorophenyl)perfluoropropane, bis(isocyanatomethylperfluorophenyl)perfluoropropane, bis(2-isocyanato-2,2-difluoroethyl)benzene, bis(2-isocyanato-1,1-difluoroethyl)benzene, mixtures of these, and the like.

As the modifications of these, there may be mentioned modifications of HDI (urethane-modified HDI, carbodiimide-modified HDI, trihydrocarbyl phosphate-modified HDI, etc.), modifications of FHMDI (urethane-modified FHMDI, carbodiimide-modified FHMDI, trihydrocarbyl phosphate-modified FHMDI, etc.), modifications of MDI (urethane-modified MDI, carbodiimide-modified MDI, trihydrocarbyl phosphate-modified MDI, etc.), modifications of TDI (urethane-modified TDI, carbodiimide-modified TDI, trihydrocarbyl phosphate-modified TDI, etc.), mixtures of these, and the like.

Also preferably employable as the polyisocyanate (A) in addition to those enumerated above are tertiary amino group-containing polyisocyanates [N,N-bis(isocyanatoethyl)methylamine, N,N-bis(4-isocyanatocyclohexyl)methylamine, etc.], quaternary ammonio group-containing polyisocyanates [N,N-bis(isocyanatoethyl)dimethylammonium chloride, N,N-bis(4-isocyanatocyclohexyl)dimethylammonium chloride, etc.], and the like. The use of these polyisocyanates results in a further increase in curability.

Preferred as the polyisocyanate (A), from the viewpoint of safety of (A) and the like, are aliphatic polyisocyanates, alicyclic polyisocyanates, tertiary amino group-containing polyisocyanates and quaternary ammonio group-containing polyisocyanates. More preferred from the reactivity and the like viewpoint are fluorine-containing aliphatic polyisocyanates, fluorine-containing alicyclic polyisocyanates, tertiary amino group-containing polyisocyanates and quaternary ammonio group-containing polyisocyanates. Especially preferred are fluorine-containing aliphatic polyisocyanates and fluorine-containing alicyclic polyisocyanates. Most preferred are those represented by OCN—CH₂—R_{f}—CH₂—NCO.

The active hydrogen-containing polymer (B) includes polyethers {hydroxyl group-containing polyethers (B1), mercapto group-containing polyethers (B2), primary and/or secondary amino group-containing polyethers (B3) and carboxyl group-containing polyethers (B4)}, polyesters {hydroxyl group-containing polyesters (B5), mercapto group-containing poly(thio)esters (B6), primary and/or secondary amino group-containing polyesters (B7) and carboxyl group-containing polyesters (B8)}, polyamides {hydroxyl group-containing polyamides (B9), mercapto group-containing polyamides (B10), primary and/or secondary amino group-containing polyamides (B11) and carboxyl group-containing polyamides (B12)}, and the like.

Employable as the hydroxyl group-containing polyethers (B1) are alkylene oxide (co)adducts derived from compounds (b) having at least two active hydrogen atoms.

As the alkylene oxide, there may be mentioned alkylene oxides containing 2 to 8 carbon atoms (ethylene oxide, propylene oxide, butylene oxide, tetrahydrofuran, styrene oxide, etc.), fluoroalkylene oxides containing 2 to 8 carbon atoms (1,1-difluoroethylene oxide, tetrafluoroethylene oxide, 3,3,3-trifluoropropylene oxide, perfluoropropylene oxide, perfluorobutylene oxide, perfluorotetrahydrofuran, perfluorostyrene oxide, etc.), and the like. Preferred as the alkylene oxide are ethylene oxide and propylene oxide, and the use of ethylene oxide alone or of a mixture of ethylene oxide and propylene oxide is preferred.

In the case of coadducts, the mode of addition may be a random or block mode, or a combination thereof. Preferred is a random one.

In cases where a fluoroethylene oxide and/or a fluoroalkylene oxide is used, it is preferred that such fluoroethylene oxide and/or fluoroalkylene oxide be subjected to addition reaction after reaction of ethylene oxide and/or an alkylene oxide with (b). The existence of a fluorine compound at termini contributes to a further increase in curability of the isocyanato group-containing polymer. Among the fluoroethylene oxides and fluoroalkylene oxides, 1,1-difluoroethylene oxide, perfluoroethylne oxide and 3,3,3-trifluoropropylene oxide are preferred, and 3,3,3-trifluoropropylene oxide is more preferred.

In the case of coadducts, the ethylene oxide content (in % by weight) based on the coadduct weight is preferably not lower than 30, more preferably not lower than 50, particularly preferably not lower than 60, most preferably not lower than 70, while it is preferably not higher than 100, more preferably not higher than 98, particularly preferably not higher than 95, most preferably not higher than 90. Within the above range, adhesive strength (in particular in initial adhesive strength) becomes higher.

Employable as the compound (b) having at least two active hydrogen atoms are water, diols, tri- to hexa- or further hydric polyols, dicarboxylic acids, tri- to tetra- or further basic polycarboxylic acids, monoamines, polyamines, polythiols and the like. When a compound having two active hydrogen atoms is used, dihydric polyols are obtained and, when a compound having three or more active hydrogen atoms is used, tri- or further hydric polyols are obtained.

Employable as the diols are alkylene glycols containing 2 to 30 carbon atoms (ethylene glycol, 1,2-propylene glycol, 1,3-propylene glycol, 1,4-butanediol, 1,6-hexanediol, octanediol, decanediol, dodecanediol, tetradecanediol, neopentyl glycol, 2,2-diethyl-1,3-propanediol, etc.); alicyclic diols containing 6 to 24 carbon atoms (1,4-cyclohexanedimethanol, hydrogenated bisphenol A, etc.); bisphenols containing 15 to 30 carbon atoms (bisphenol A, bisphenol F, bisphenol S, etc.); dihydroxybenzenes (catechol, hydroquinone, etc.); polyester diols having a weight average molecular weight (Mw) of 100 to 5,000 [polylactone diols (poly-ε-caprolactone diol, etc.), aliphatic polyester diols (ethylene glycol/adipic acid polyester diol, butylene glycol/adipic acid polyester diol, etc.), aromatic polyester diols (ethylene glycol/terephthalic acid polyester diol etc.), etc.), and polybutadiene diols having an Mw of 1,000 to 20,000; and the like. The Mw can be determined by gel permeation chromatography (GPC) using polyethylene glycol species or polystyrene species as standard substances.

Employable as the tri- to hexahydric polyols are aliphatic polyhydric (tri- to hexahydric) alcohols containing 3 to 8 carbon atoms (glycerol, trimethylolethane, trimethylolpropane, pentaerythritol, sorbitan, sorbitol, etc.), and the like.

Employable as the dicarboxylic acids are alkanedicarboxylic acids containing 4 to 32 carbon atoms (succinic acid, adipic acid, sebacic acid, dodecenylsuccinic acid, azelaic acid, sebacic acid, dodecanedicarboxylic acid, octadecanedicarboxylic acid, dodecylsuccinic acid, octadecylsuccinic acid, etc.); alkenedicarboxylic acids containing 4 to 32 carbon atoms (maleic acid, fumaric acid, citraconic acid, mesaconic acid, dimer acid, dodecenylsuccinic acid, pentadecenylsuccinic acid, etc.); aromatic dicarboxylic acids containing 8 to 20 carbon atoms (phthalic acid, isophthalic acid, terephthalic acid, naphthalenedicarboxylic acid, etc.); and the like.

Employable as the tri- or tetrabasic or further basic polycarboxylic acids are aromatic polycarboxylic acids (trimellitic acid, pyromellitic acid, etc.), and the like.

These dicarboxylic acids or polycarboxylic acids may be used in the form of acid anhydrides, lower alkyl esters or the like as well. As the acid anhydrides of these dicarboxylic acids or polycarboxylic acids, there may be mentioned maleic anhydride, phthalic anhydride, trimellitic anhydride, pyromellitic anhydride, and the like. Usable as the lower alkyl are alkyl groups containing 1 to 4 carbon atoms. Thus, methyl, ethyl, isopropyl, tert-butyl and the like may be mentioned.

Employable as the monoamines are ammonia; aliphatic amines containing 1 to 20 carbon atoms {alkylamines containing 1 to 20 carbon atoms (methylamine, ethylamine, propylamine, hexylamine, dedecylamine, eicosylamine, etc.) etc.}; alicylic amines containing 4 to 15 carbon atoms (aminocyclohexane, isophoronemonoamine and 4-methylenedicyclohexanemonoamine); heterocyclic amines containing 4 to 15 carbon atoms (piperidine, N-aminoethylpyridine, etc.); aromatic ring-containing aliphatic amines containing 6 to 15 carbon atoms (aminomethylbenzene etc.); aromatic amines containing 6 to 15 carbon atoms (aniline etc.); and the like.

Employable as the polyamines are aliphatic polyamines containing 2 to 18 carbon atoms {alkylenediamines containing 2 to 12 carbon atoms (ethylenediamine, propylenediamine, trimethylenediamine, hexamethylenediamine, undecylenediamine, etc.), polyalkylenepolyamines (alkylene has 2 to 6 carbon atoms) (diethylenetriamine, dipropylenetriamine, triethylenetetramine, pentaethylenehexamine, etc.), and the like}, alicyclic polyamines containing 4 to 15 carbon atoms (1,3-diaminocyclohexane, isophoronediamine and 4,4′-methylenedicyclohexanediamine); heterocyclic polyamines containing 4 to 15 carbon atoms (piperazine, N-aminoethylpiperazine, 1,4-diaminoethylpiperazine, etc.); aromatic ring-containing aliphatic amines containing 8 to 15 carbon atoms (xylylenediamine, tetrachloro-p-xylylenediamine, etc.); aromatic polyamines containing 6 to 20 carbon atoms (phenylenediamine, bis(aminophenyl)methane, 4-aminophenyl-2-chloroaniline, 1-methyl-2-methylamino-4-aminobenzene, etc.); and the like.

Employable as the polythiols are hydrogen sulfide, polythiols containing 1 to 24 carbon atoms (methanedithiol, ethanedithiol, 1,4-butanedithiol, 1,6-hexanedithiol, 1,2,3-propanetrithiol, etc.) and the like.

In addition to those compounds, aminocarboxylic acids, hydroxycarboxylic acids, amino alcohols and the like can also be used as the compound (b) having at least two active hydrogen atoms.

Among those compounds (b) having at least two active hydrogen atoms, diols are preferred, alkylene glycols are more preferred, alkylene glycols containing 2 to 30 carbon atoms are particularly preferred, and alkylene glycols containing 2 to 4 carbon atoms (ethylene glycol, 1,2-propylene glycol, 1,3-propylene glycol, 1,4-butanediol, etc.) are most preferred.

An amino group-containing compound (b1) having at least two active hydrogen atoms, a quaternary ammonio group-containing compound (b2) having at least two active hydrogen atoms, mixtures of these, and the like can also be preferably used as the compound (b) having at least two active hydrogen atoms. When (b1) or (b2) is used, the reactivity of the polymer becomes higher.

Usable as the compound (b1) are monoamines, polyamines, and the like. As the monoamines, there may be mentioned ammonia and monoamino compounds containing 1 to 20 carbon atoms [aliphatic amines (methylamine, ethylamine, propylamine, hexylamine, dodecylamine, eicosylamine, etc.); alicyclic amines (cyclohexylamine, isophoronemonoamine, 4-cyclohexylmethylcyclohexylamine, 4-dicyclohexylmethylcyclohexylamine, etc.); heterocyclic amines (piperidine, N-aminoethylpiperidine, etc.); aromatic ring-containing aliphatic amines (aminomethylbenzene etc.); aromatic amines (aniline etc.), etc.]; and the like.

As the polyamines, there may be mentioned polyamines containing 2 to 18 carbon atoms {aliphatic polyamines [alkylenediamines (ethylenediamine, propylenediamine, trimethylenediamine, hexamethylenediamine, undecylenediamine, etc.), dialkylaminoalkylamines (dimethylaminoethylamine, diethylaminopropylamine, dipropylaminopropylamine, methylethylaminopropylamine and dioctadecylaminoethylamine), N,N′-dialkylalkylenediamines (N,N′-dimethylethylenediamine etc.), polyalkylenepolyamines (diethylenetriamine, dipropylenetriamine, triethylenetetramine, pentaethylenehexamine, etc.), etc.]; alicyclic polyamines (1,3-diaminocyclohexane, isophoronediamine and 4,4′-methylenedicyclohexanediamine); heterocyclic polyamines (piperazine, N-aminoethylpiperazine, 1,4-diaminoethylpiperazine, etc.); aromatic ring-containing aliphatic amines (xylylenediamine, tetrachloro-p-xylylenediamine, etc.); aromatic polyamines (phenylenediamine, bis(aminophenyl)methane, 4-aminophenyl-2-chloroaniline, 1-methyl-2-methylamino-4-aminobenzene, etc.), etc.}; and the like.

Also preferably employable as the compound (b1) are tertiary amino group-containing polyols (2-dimethylaminopropanediol, 2-diethylaminoethylpropanediol, dimethylaminoethylcyclohexanediol, etc.), tertiary amino group-containing polythiols [bis(mercaptoethyl)methylamine etc.], tertiary amino group-containing polycarboxylic acids (2-dimethylaminoethyladipic acid etc.), and the like. When these are used, the reactivity of the polymer becomes higher.

Preferred as the compound (b1) are aliphatic amines, alicyclic amines, dialkylaminoalkylamines and N,N′-dialkylalkylenediamines. More preferred are aliphatic amines, dialkylaminoalkylamines and N,N′-dialkylalkylenediamines. Most preferred are dialkylaminoalkylamines.

As the quaternary ammonio group-containing compound (b2) having at least two active hydrogen atoms, there may be mentioned compounds resulting from conversion of the amino group or groups of the amino group-containing compound (b1) having at least two active hydrogen atoms to ammonium {Lewis acid salts of primary amines or secondary amines, Broensted acid salts of tertiary amines [monoamine salts (dimethylammonium chloride, N-methyl-N-cyclohexylammonium methyl sulfate, etc.), polyamine salts (tetramethylethylenediammonium bisnitrate etc.)], quaternization products derived from tertiary amino group-containing polyols (2-trimethylammoniopropanediol chloride etc.), quaternization products derived from tertiary amino group-containing polythiols [bis(mercaptoethyl)dimethylammonium chloride etc.] quaternization products derived from tertiary amino group-containing polycarboxylic acids (2-trimethylammonioethyladipic acid chloride-etc.) etc.] etc.}, and the like.

As the Broensted acid, there may be mentioned hydrochloric acid, nitric acid, sulfuric acid, formic acid, acetic acid, benzoic acid and the like, and as the Lewis acid, there may be mentioned such Broensted acids and alkyl halides (alkyl has 1 to 20 carbon atoms) (methyl chloride, methyl bromide, ethyl chloride, decyl chloride, decyl bromide, eicosyl chloride, benzyl chloride, benzyl bromide, epichlorohydrin, etc.), alkylated inorganic acids (alkyl has 1 to 7 carbon atoms) (dimethyl sulfate, benzyl sulfate etc.), dialkyl carbonates (alkyl has 1 to 7 carbon atoms) (dimethyl carbonate, dibenzyl carbonate, etc.), and the like.

The hydroxyl group-containing polyethers (B1) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the mercapto group-containing polyethers (B2) are those ones having a structure resulting from conversion of at least one hydroxyl group of the hydroxyl group-containing polyether (B1) to a mercapto group, and the like, including those ones having a structure obtained by reacting the hydroxyl group-containing polyether (B1) with an epihalohydrin (e.g. epichlorohydrin etc.), followed by reaction with hydrogen sulfide, those ones having a structure obtained by directly reacting the hydroxyl group-containing polyether (B1) with a cyclic thioether (e.g. ethylene sulfoxide etc.), and the like.

The mercapto group-containing polyethers (B2) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the primary and/or secondary amino group-containing polyethers (B3) are those ones having a structure resulting from conversion of at least one hydroxyl group of the hydroxyl group-containing polyether (B1) or at least one mercapto group of a mercapto group-containing polyether (B2) to a primary and/or secondary amino group, and the like, including those ones having a structure obtained by reacting (B1) or (B2) with a cyclic amine (e.g. ethylenimine, N-methylethylenimine and the like) and the like, those ones having a structure resulting from (co)addition polymerization of an alkylene oxide on a ketimine compound obtained from a hydroxyl group-containing primary amine (e.g. ethanolamine etc.) and a ketone (e.g. methyl ethyl ketone etc.), followed by hydrolysis for ketone elimination and conversion to a primary amine, and the like.

The primary and/or secondary amino group-containing polyethers (B3) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the carboxyl group-containing polyethers (B4) are those ones having a structure resulting from conversion of at least one hydroxyl group of the hydroxyl group-containing polyether (Bi) or at least one mercapto group of the mercapto group-containing polyether (B2) to a carboxyl group, and the like, including those ones having a structure obtained by reacting (B1) or (B2) with the acid anhydride or an alkyl ester of such a dicarboxylic acid or polycarboxylic acid as mentioned above etc., those ones having a structure resulting from conversion of a hydroxyl group(s) of (B1) to a carboxyl group(s) by oxidation in the presence of an oxidizing agent (e.g. platinum compound, chromic mixed acid, permanganate salts and the like), those ones having a structure obtained by (co)addition polymerization of an alkylene oxide containing ethylene oxide as an essential constituent on a hydroxy acid lower alcohol ester (e.g. methyl lactate etc.), followed by hydrolysis for alcohol elimination and conversion to a carboxyl group(s), and the like.

The carboxyl group-containing polyethers (B4) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the hydroxyl group-containing polyesters (B5) are polyesters of (B1) with the above-mentioned dicarboxylic acids, dicarboxylic acid anhydrides and/or dicarboxylic acid lower alkyl esters, and the like. The termini of these polyesters are hydroxyl groups. Polycarboxylic acids, polycarboxylic acid anhydrides, polycarboxylic acid lower alkyl esters and the like may also be used and, when these are used, the proportion thereof (in mole percent) is preferably 0.1 to 10, more preferably 0.1 to 5, most preferably 0.1 to 2, based on the number of moles of all carboxylic acids. The (B1) to be used for obtaining (B5) is preferably one having a Mn of not lower than 100 but not higher than 5,000.

The hydroxyl group-containing polyesters (B5) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the mercapto group-containing poly(thio)ethers (B6) are those ones having a structure resulting from conversion of at least one hydroxyl group of the hydroxyl group-containing polyester (B5) to a mercapto group (those ones having a structure obtained by reacting the hydroxyl group-containing polyester (B5) with an epihalohydrin, followed by reaction with hydrogen sulfide, those ones having a structure obtained by directly reacting the hydroxyl group-containing polyester (B5) with a cyclic thio ether, etc.], polythioesters (with at least one terminus being a mercapto group) producible from the mercapto group-containing polyethers (B2) and the above-mentioned dicarboxylic acids, dicarboxylic acid anhydrides and/or dicarboxylic acid lower alkyl esters, and the like. The (B2) to be used for obtaining (B6) preferably has a Mn of not lower than 100 but not higher than 5,000.

The mercapto group-containing poly(thio)esters (B6) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the primary and/or secondary amino group-containing polyesters (B7) are those ones having a structure resulting from conversion of at least one hydroxyl group of the hydroxyl group-containing polyester (B5) to a primary and/or secondary amino group, and the like, including those ones having a structure obtained by reacting the hydroxyl group-containing polyester (B5) with a cyclic amine, and the like.

The primary and/or secondary amino group-containing polyethers (B7) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the carboxyl group-containing polyesters (B8) are those ones having a structure resulting from conversion of at least one hydroxyl group of the hydroxyl group-containing polyester (B5) to a carboxyl group [those ones having a structure obtained by reacting the hydroxy group-containing polyester (B5) with such a dicarboxylic acid, dicarboxylic acid anhydride and/or the like as mentioned above, those ones having a structure (with at least one terminus being a carboxyl group) obtained by reacting the carboxyl group-containing polyether (B4) with such a polyol as mentioned above, and the like, etc.], and the like. The (B4) to be used for obtaining (B8) preferably has a Mn of not lower than 100 but not higher than 5,000.

The carboxyl group-containing polyesters (B8) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the hydroxyl group-containing polyamides (B9) are those ones having a structure resulting from conversion of at least one amino group or carboxyl group of a polyamide derived from the primary and/or secondary amino group-containing polyether (B3) and such a dicarboxylic acid, di- or polycarboxylic acid anhydride and/or dicarboxylic acid lower alkyl ester as mentioned above, a polyamide derived from the carboxyl group-containing polyether (B4) and such a polyamine as mentioned above, or the like to a hydroxyl group [those ones having a structure obtained by reacting such a polyamide with an alkylene oxide, those ones having a structure obtained by reacting such a polyamide with an epihalohydrin, followed by hydrolysis, etc.], and the like. The (B3) and (B4) to be used for obtaining (B9) each preferably has a Mn of not lower than 100 but not higher than 5,000.

The hydroxyl group-containing polyamides (B9) preferably have a Mn of not lower than 200, more preferably not lower than 300, most preferably not lower than 400, and preferably not higher than 10,000, more preferably not higher than 8,000, most preferably not higher than 6,000.

Within such range, the adhesive strength (in particular wet adhesive strength) becomes higher.

Employable as the mercapto group-containing polyamides (B10) are those ones having a structure resulting from conversion of at least one amino group or carboxyl group of a polyamide derived from the primary and/or secondary amino group-containing polyether (B3) and such a dicarboxylic acid, di- or polycarboxylic acid anhydride and/or dicarboxylic acid lower alkyl ester as mentioned above, the polyamide derived from a carboxyl group-containing polyether (B4) and such a polyamine as mentioned above, or the like to a mercapto group [those ones having a structure obtained by reacting such a polyamide with an epihalohydrin, followed by reaction with hydrogen sulfide, those ones having a structure obtained by directly reacting such a polyamide with a cyclic thioether, etc.], and the like. The (B3) and (B4) to be used for obtaining (BlO) each preferably has a Mn of not lower than 100 but not higher than 5,000.

The mercapto group-containing polyamides (B10) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the primary and/or secondary amino group-containing polyamides (B11) are those ones having a structure obtained by reacting the primary and/or secondary amino group-containing polyether (B3) with such a dicarboxylic acid, di- or polycarboxylic acid anhydride and/or dicarboxylic acid lower alkyl ester as mentioned above (with at least one terminus being a primary and/or secondary amino group), those ones having a structure obtained by reacting the carboxyl group-containing polyether (B4) with such a polyamine as mentioned above (with at least one terminus being a primary and/or secondary amino group), and the like. The (B3) and (B4) to be used for obtaining (B11) each preferably has a Mn of not lower than 100 but not higher than 5,000.

The primary and/or secondary amino group-containing polyamides (B11) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Employable as the carboxyl group-containing polyamides (B12) are those ones having a structure obtained by reacting the primary and/or secondary amino group-containing polyether (B3) with such a dicarboxylic acid, di- or polycarboxylic acid anhydride or dicarboxylic acid lower alkyl ester as mentioned above (with at least one terminus being a carboxyl group), those ones having a structure obtained by reacting the carboxyl group-containing polyether (B4) with such a polyamine as mentioned above (with at least one terminus being a carboxyl group), and the like. The (B3) and (B4) to be used for obtaining (B12) each preferably has a Mn of not lower than 100 but not higher than 5,000.

The carboxyl group-containing polyamides (B12) preferably have a Mn of not lower than 200, more preferably not lower than 300, most preferably not lower than 400, and preferably not higher than 10,000, more preferably not higher than 8,000, most preferably not higher than 6,000. Within such range, the adhesive strength (in particular wet adhesive strength) becomes higher.

Preferred as the active hydrogen-containing polymer (B) are those hydroxyl group- or mercapto group-containing ones {the hydroxyl group-containing polyethers (B1), the mercapto group-containing polyethers (B2), the hydroxy group-containing polyesters (B5), the mercapto group-containing poly(thio)esters (B6), the hydroxyl group-containing polyamides (B9) and the mercapto group-containing polyamides (B10)}. More preferred are (B1), (B2), (B5) and (B6). Most preferred are (B1) and (B5).

Among the active hydrogen-containing polymers (B), those ester bond-containing ones (the carboxyl group-containing polyethers (B4), the hydroxyl group-containing polyesters (B5), the mercapto group-containing poly(thio)esters (B6), the primary and/or secondary amino group-containing polyesters (B7), the carboxyl group-containing polyesters (B8), etc.} have ready hydrolyzability, hence are preferably used in those cases where the long-term in vivo existence of the polymer of the invention, when used in adhesion of vital tissues, is undesirable for some or other reasons. When those ones having a bond represented by —R¹—(CH₂),—COO—are used as the active hydrogen-containing polymer (B), enhanced ready hydrolyzability preferably results. In the formula, n represents an integer of 0 to 2, and R¹ represents a carbonyl group or an electron-attracting characteristic group —C(X) (Y)—{X representing F, Cl, Br, NO₂ or CN and Y representing H, F, Cl, Br or CN}. When the active hydrogen-containing polymer (B) having such a bond is used, the resulting polymer of the invention, when used in adhesion of vital tissues, can show good hydrolyzability. As such active hydrogen-containing polymer (B), there may be mentioned esters of a-ketoglutaric acid with polyethylene glycol (cf. Japanese Kokai Publication Hei-02-20 327392, Japanese Kokai Publication Hei-03-163590 or the like), and the like.

From the adhesive strength (in particular initial adhesive strength) and the like viewpoint, the active hydrogen-containing polymer (B) is preferably a hydrophilic polymer. The term “hydrophilic polymer” means a polymer having a polyoxyethylene group content of not lower than 30% by weight per molecule or one comparable in affinity for water thereto. In cases where an active hydrogen-containing polymer which is not a hydrophilic one is used, the content (in % by weight) of this active hydrogen-containing polymer is preferably not lower than 1, more preferably not lower than 2, particularly preferably not lower than 5, most preferably not lower than 8, and preferably not higher than 70, more preferably not higher than 50, particularly preferably not higher than 20, most preferably not higher than 15, based on the total weight of the active hydrogen-containing polymer (B), from the adhesive strength (in particular initial adhesive strength) and the like viewpoint. The oxyethylene group content (in % by weight) in the active hydrogen-containing polymer (B) is preferably not lower than 30, more preferably not lower than 50, particularly preferably not lower than 65, most preferably not lower than 70, and preferably not higher than 100, more preferably not higher than 98, particularly preferably not higher than 95, most preferably not higher than 90, based on the weight of (B). When the content of the active hydrogen-containing polymer which is not hydrophilic and the oxyethylene group content are within such respective ranges, the adhesive strength (in particular initial adhesive strength) becomes higher.

From the adhesive strength (in particular wet adhesive strength) and the like viewpoint, the active hydrogen-containing polymer (B) preferably has an active hydrogen equivalent (molecular weight per equivalent of active hydrogen) of not less than 50, more preferably not less than 100, most preferably not less than 200, and preferably not more than 5,000, more preferably not more than 4,000, most preferably not more than 3,000. The active hydrogen equivalent can be determined by treatment with an excess amount of a carboxylic acid anhydride (e.g. acetic anhydride etc.), titrating the unreacted carboxylic acid anhydride with an aqueous solution of potassium hydroxide and the like, and calculating the number of moles of the functional group per unit weight.

The active hydrogen-containing polymer (B) preferably has a Mn of not lower than 200, more preferably not lower than 300, particularly preferably not lower than 400, most preferably not lower than 1,000, and preferably not higher than 10,000, more preferably not higher than 8,000, particularly preferably not higher than 6,000, most preferably not higher than 4,000. Within such range, the adhesive strength (in particular wet adhesive strength) becomes higher.

Preferred as the active hydrogen-containing polymer (B), from the adhesive strength (in particular initial adhesive strength) and the like viewpoint, are ethylene oxide-propylene oxide random copolymers, and mixtures of ethylene oxide-propylene oxide random copolymers and propylene oxide polymers. Most preferred are mixtures of ethylene oxide-propylene oxide random copolymers and propylene oxide polymers. Most preferred as the ethylene oxide-propylene oxide random copolymers are those ones produced using water, ethylene glycol and/or propylene glycol as an active hydrogen-containing compound and having a Mn of 1,000 to 6,000 and an oxyethylene group content of 60 to 90% by weight.

When a trivalent or further polyvalent active hydrogen-containing polymer is used as the active hydrogen-containing polymer (B), the content thereof (in % by weight) is preferably not lower than 0.01, more preferably not lower than 0.1, most preferably not lower than 0.2, and preferably not higher than 5, more preferably not higher than 1, most preferably not higher than 0.8, based on the weight of the polyisocyanate (A). Within such range, the adhesive strength (in particular wet adhesive strength) becomes higher.

The alkali metal and alkaline earth metal content (in mmol/kg) in the active hydrogen-containing polymer (B) is preferably 0 (zero) or below 0.07, more preferably 0 or below 0.04, particularly preferably 0 or below 0.02, most preferably 0 or below 0.01, based on the weight of (B). Within such range, it is easy to prevent some or other abnormal reactions from occurring in the reaction between the isocyanate (A) and the active hydrogen-containing polymer (B). The alkali metal and alkaline earth metal content in the active hydrogen-containing polymer (B) can be determined by subjecting a 30% (by weight) methanol solution of (B) or an aqueous solution prepared by heating and incinerating 10 g of (B) on, a platinum dish and dissolving the ash in 10 g of water to ion chromatography, by titrating a solution prepared by dissolving 30 g of (B) in 100 ml of methanol with 1/100 N aqueous hydrochloric acid, or by the like method.

The alkali metal or alkaline earth metal is admixed mainly as a catalyst in polyether polyol synthesis. As such catalyst, there may be mentioned hydroxides (potassium hydroxide, sodium hydroxide, cesium hydroxide, beryllium hydroxide, magnesium hydroxide, etc.), alcoholates (lithium methylate, sodium ethylate, potassium butylate, magnesium hexylate, etc.), simple substance metals (potassium, sodium, lithium, magnesium, calcium, etc.), and the like. In many instances, such a catalyst remains in the active hydrogen-containing polymer (B) in an amount of 0.1 to 0.3 mmol/kg. Therefore, it is recommended that a polyether polyol low in alkali metal and alkaline earth metal content, and the like, be used so that the alkali metal and alkaline earth metal content in the active hydrogen-containing polymer (B) may fall within the above range.

Such polyether polyol low in alkali metal and alkaline earth metal content can be obtained by removing the alkali metal and alkaline earth metal catalysts from a crude polyether polyol obtained by addition polymerization of an alkylene oxide on an active hydrogen-containing compound in the presence of such a catalyst as mentioned above, by-carrying out the alkylene oxide addition polymerization reaction in the presence of an alkali metal- and alkaline earth metal-free catalyst, such as a composite metal cyanide complex (e.g. zinc hexacyanocobaltate-polyether complex catalyst etc.), an organoboron compound [e.g. trifluoroboric acid, tris(pentafluorophenyl)borane etc.] or a transition metal complex catalyst, as disclosed in Japanese Kokai Publication Hei-08-104741, or by the like method. As the method of alkali metal and alkaline earth metal elimination from the crude polyether polyol, there may be mentioned the method comprising treatment with an adsorbent, the method comprising treatment with an ion exchanger, and the like method.

As the adsorbent, there may be mentioned silicates (magnesium silicate, talc, soapstone, stealite, calcium silicate, magnesium aluminosilicate, sodium aluminosilicate, etc.), clay species (activated clay, acid clay, etc.), hydrotalcite, silica gel, diatomaceous earth, activated alumina and the like. Among these adsorbents, silicate salts are preferred, and magnesium silicate is more preferred.

Among the magnesium silicate species, synthetic magnesium silicate species are preferred. More preferred are magnesium silicate species having a sodium content of not higher than 0.5% by weight, as disclosed in Japanese Kokai Publication Hei-07-258403.

The adsorption treatment can be carried out by adding water and magnesium silicate to and mixing them with the crude polyether polyol, as described in Japanese Kokai Publication Hei-07-258403.

The level of addition of water is preferably 0.01 to 50% by weight relative to the crude polyether polyol, and the level of addition of magnesium silicate is 0.01 to 50% by weight on the same basis. The adsorption treatment temperature is not particularly restricted but preferably 60 to 200° C., and the oxygen concentration in the gaseous phase is preferably not higher than 1,000 ppm. The adsorption treatment time is not particularly restricted but preferably is 0.5 to 24 hours. After adsorption treatment, the treatment mixture is filtered through a filter paper, filter cloth, glass filter or like filtration apparatus, optionally followed by dehydration, whereby an active hydrogen-containing polymer (B) low in alkali metal and alkaline earth metal content can be produced. In case the alkali metal and alkaline earth metal content is above the above range even after adsorption treatment, the alkali metal and alkaline earth metal content can be reduced by carrying out the adsorption treatment again.

As the ion exchanger, there may be mentioned strong cation exchange resins, weak cation exchange resins, chelating resins, and the like. As the method of ion exchange treatment, there may be mentioned the method comprising adding water to the crude polyether polyol, admixing an ion exchanger with the mixture with stirring and removing the ion exchanger by filtration, the method comprising passage through a column packed with an ion exchanger, or the like method. The level of addition of water (in % by weight) is preferably not lower than 0.01, more preferably not lower than 1, and preferably not higher than 80, more preferably not higher than 60, based on the weight of the crude polyether polyol. The usage of the ion exchanger is preferably not lower than 0.1% by weight, more preferably not lower than 1%, and preferably not higher than 50% by weight, more preferably not higher than 30% by weight, based on the weight of the aqueous solution mentioned above. The mixing temperature (in ° C.) is preferably not lower than 5, more preferably not lower than 20, and preferably not higher than 80, more preferably not higher than 40. The mixing time (in hours) is preferably Xnot shorter than 1, more preferably not shorter than 5, most preferably shorter than 24.

In carrying out the filtration, such a filtration apparatus as a filter paper, filter cloth or glass filter is used.

On the occasion of passage through a column packed with an ion exchanger, the liquid temperature (in ° C.) is preferably not lower than 5, more preferably not lower than 20, and preferably not higher than 80, more preferably not higher than 40. Although one passage through the column will be sufficient, the passage through the column may be repeated two to fifty times. As the method of dehydration to be carried out according to need, there may be mentioned the method comprising distilling off water at 50 to 150° C. and 0.001 hPa to ordinary pressure for 1 to 10 hours, optionally while passing an inert gas such as nitrogen, and the like method.

In cases where the active hydrogen-containing polymer (B) is a tertiary amino group- and/or quaternary ammonio group-containing one, the content of such group (number of groups/g) is preferably not smaller than 1×10¹⁷, more preferably not smaller than 1×10¹⁸, most preferably not smaller than 1×10¹⁹, and preferably not greater than 1×10²³, more preferably not greater than 1×10²², most preferably not greater than 1×10²¹, based on the weight of (B) from the polymer curability and the like viewpoint. The number of tertiary amino groups and quaternary ammonio groups can be determined by calculation based on ¹H-NMR data or by potentiometric titration with 1/100 N aqueous hydrochloric acid following sample treatment with excess aqueous sodium hydroxide.

As the tertiary amino group- and/or quaternary ammonio group-containing, and active hydrogen-containing polymer, there may be mentioned those ones having a structure obtained by addition of an alkylene oxide to the amino group-containing compound (b1) having at least two active hydrogen atoms, the quaternary ammonio group-containing compound (b2) having at least two active hydrogen atoms and a mixture of these, and the like.

The urethane prepolymer (UP) is obtained by reacting the polyisocyanate (A) with the active hydrogen-containing polymer (B). The usage ratio between the polyisocyanate (A) and the active hydrogen-containing polymer (B) as expressed in terms of equivalent ratio (A/B) between the isocyanato groups in (A) and the active hydrogen atoms in (B) is preferably not lower than 1.5, more preferably not lower than 1.8, particularly preferably not lower than 1.9, most preferably not lower than 1.95, and preferably not higher than 5.0, more preferably not higher than 3.0, particularly preferably not higher than 2.3, further preferably not higher than 2.1, most preferably not higher than 2.0. Within such range, the adhesive strength (in particular initial adhesive strength) becomes higher.

The urethane prepolymer (UP) can be produced by a method known in the art, for example by applying the method comprising mixing the polyisocyanate (A) and the active hydrogen-containing polymer (B) together and allowing the reaction to proceed at 50 to 100° C. for 1 to 10 hours, and the like method. Since, upon reaction with water, the isocyanato groups in (A) are converted to amino groups, it is necessary to eliminate water in the reaction vessel and raw materials as far as possible in the production process. Therefore, it is desirable that (B) be reacted with (A) after dehydration of (B). Applicable as the method of dehydration are the method comprising distilling off water at 50 to 150° C. and 0.001 hPa to ordinary pressure for 1 to 10 hours, optionally while passing an inert gas such as nitrogen, and the like method.

The method of mixing the polyisocyanate (A) and the active hydrogen-containing polymer (B) may be (1) the one comprising mixing them together all at once, (2) the one comprising gradual dropwise addition of (B), or (3) the one comprising mixing (A) with a part of (B) and, after a predetermined period of reaction, adding the remaining portion of (B) dropwise or all at once. Among these, the methods (1) and (2) are preferred because of ease of reaction procedure and, from this viewpoint, the method (1) is more preferred. From the viewpoint that the amount of the unreacted polyisocyanate component can be reduced, the method (3) is preferred.

This reaction may be carried out in the presence of a catalyst (e.g. an organometallic compound such as dibutyltin oxide or dibutyltin dilaurate, an organic acid metal salt such as zirconium acetate, or the like), and this mode of reaction is effective particularly in cases where an aliphatic isocyanate is used.

The urethane prepolymer (UP) preferably has a Mn of not lower than 500, more preferably not lower than 800, particularly preferably not lower than 1,000, most preferably not lower than 1,200, and preferably not higher than 500,000, more preferably not higher than 100,000, particularly preferably not higher than 10,000, most preferably not higher than 5,000. Within such range, the adhesive strength (in particular wet adhesive strength) becomes higher. The content (in % by weight) of the urethane prepolymer having a Mn of 500 to 500,000 is preferably not lower than 98 but not higher than 100, more preferably not lower than 98.5, particularly preferably not lower than 99, most preferably not lower than 99.5, based on the weight of (UP). Within such range, the adhesive strength of the adhesive becomes higher.

The content of those urethane prepolymer molecules whose molecular weight is within a specific range (isocyanato group-containing urethane polymers) in the urethane prepolymer (UP) can be estimated by comparing the molecular weight distribution curve for urethane prepolymer molecules having a Mn of 500 to 500,000 as obtained by GPC, using an ultraviolet detector, of the product of reaction with an amine having one primary or secondary amino group and capable of absorbing light at wavelengths in the ultraviolet region (e.g. 4-aminopyridine, aminonaphthalene etc.) (standard substances: N-methylaminopyridine-ethylene oxide adducts) and the molecular weight distribution curve obtained by GPC using a refractive index detector following reaction with an amine having one primary or secondary amino group and incapable of absorbing light at wavelengths in the ultraviolet region (e.g. ethylamine, dibutylamine etc.) (standard substances: polyethylene glycols). Thus, taking the functional groups of the polymer into consideration, the determination can be realized by following the procedure comprising the following steps (1) to (5) in that order:
(1) The urethane prepolymer (UP) is mixed with an amine having one primary or secondary amino group and incapable of absorbing light at wavelengths in the ultraviolet region (e.g. ethylamine, dibutylamine etc.) to allow the reaction between the amino group and the isocyanato group to proceed, and the reaction product is subjected to GPC using a refractive index detector for Mn determination.
(2) The average number of isocyanato groups per molecule (AN) is determined based on the isocyanato group content (% by weight).
(3) (UP) is mixed with an amine having one primary or secondary amino group and capable of absorbing light at wavelengths in the ultraviolet region (e.g. 4-aminopyridine, aminonaphthalene etc.) for reaction with the isocyanato group, and the product having the functional group capable of absorbing light at wavelengths in the ultraviolet region (UVF) as introduced therein is subjected to GPC using an ultraviolet detector for Mn determination. The molecular weight distribution is determined by comparing with the standard substances.
(4) Based on this molecular weight distribution, the number of functional groups in urethane prepolymer molecules with a Mn of 500 to 500,000 (UVF) is calculated.
(5) From this and the average number (AN), the content of those urethane prepolymer molecules having a Mn of 500 to 500,000 as contained in the urethane prepolymer (UP) is estimated. The standard substances corresponding to typical molecular weights can be obtained by fractionation of the product of the addition of ethylene oxide to N-methylaminopyridine or the like by preparative GPC.

A method of obtaining a polymer in which the content of urethane prepolymer molecules having a Mn of 500 to 500,000 is 98 to 100% by weight comprises mixing the polyisocyanate (A) mentioned above with a part of the active hydrogen-containing polymer (B) and, after a predetermined period of reaction, admixing the remaining portion of (B) dropwise or all at once. Alternatively, by removing unreacted (A) after completion of the above reaction, it is also possible to increase the content of urethane prepolymer molecules having a Mn of 500 to 500,000 to 98 to 100% by weight. As the method of removing unreacted (A), there may be mentioned (1) the method consisting in fractionation using GPC, (2) the method consisting in dialysis using a semipermeable membrane, (3) the method consisting in distilling off, and the like method. From the ease of operation viewpoint, the distillation method (3) is preferred. As for the process for distilling off, there may be mentioned the process comprising distilling off unreacted (A) in the manner of reduced pressure distillation (1 to 10 hours of distillation at 50 to 150° C. and 0.001 hPa to ordinary pressure, optionally while passing an inert gas such as nitrogen), and the like process.

As the non-polyisocyanate-based polymer (NUP) having a structure resulting from conversion of one or more of the functional groups in the active hydrogen-containing polymer to an isocyanato group, among the isocyanato group-containing polymers, there may be mentioned those ones having a structure obtainable by converting one or more of the functional groups of the above-mentioned active hydrogen-containing polymer (B) directly to isocyanato groups, by introducing the isocyanato group(s) via an ether bond and/or ester bond, and by the like method, and the like.

In converting at least one of the functional groups (hydroxyl, mercapto, carboxyl, amino and the like groups) of the active hydrogen-containing polymer (B) to an isocyanato group, any of the methods known in the art and the like method can be applied. Thus, in the case of a primary hydroxyl or primary mercapto group, there may be mentioned (1) the method involving conversion to an isocyanato group via an acid azide and thus comprising converting the functional group to a carboxyl group by oxidation and further to an acid halide, followed by reaction with an azide compound and further by thermal decomposition (e.g. Japanese Kokai Publication Sho-57-108055 etc.), (2) the method comprising converting the functional group to a carboxyl group by oxidation, converting thus-obtained carboxyl group to an amino group using an azide compound, and converting the resulting amino group to an isocyanato group, and the like method. In the case of a secondary hydroxyl or secondary mercapto group, there may be mentioned (3) the method comprising converting the functional group to a carbonyl group by oxidation, converting this to an amino group by reaction with ammonia and simultaneous reduction with hydrogen, and converting this amino group to an isocyanato group, and the like method. In the case of a primary or secondary hydroxyl or primary or secondary mercapto group, there may be mentioned (4) the method comprising converting the functional group to an amino group, followed by reaction with phosgene for conversion to an isocyanato group, (5) the method comprising reacting (B) with an isocyanato group-containing unsaturated compound, and the like method. Furthermore, when the functional group is a carboxyl group, those steps of the method (1) or (2) which follow the conversion to a carboxyl group can be applied. It is also possible to utilize the method (5). When the functional group is an amino group, those steps of the method (3) or (4) which follow the conversion to an amino group can be applied.

As the method of converting the functional group (hydroxyl group) of (B) to a carboxyl group, there may be mentioned the methods based on carboxymethyl etherification (e.g. the method comprising reacting the active hydrogen-containing polymer (B) with a halogenated carboxylic acid (e.g. chloroacetic acid, chlorodifluoroacetic acid, 3-chloropropionic acid, 3-chloro-2,2-difluoropropionic acid, 4-chlorobutanoic acid, chloromethylbenzoic acid etc.) in the presence of an alkali catalyst (e.g. sodium hydroxide, potassium hydroxide etc.), and the like method], the methods based on oxidation [e.g. the method comprising heating in an aqueous alkali solution in the presence of potassium permanganate or the like, the method based on air oxidation using a platinum catalyst (e.g. platinum-activated carbon, platinum black etc.) in the presence of a weakly basic compound (e.g. sodium hydrogen carbonate, potassium carbonate etc.), the method comprising heating under sulfuric acid-due acidic conditions in the presence of a hexavalent chromium compound or the like, and the like method], and the like method. As the method of converting the carboxylic acid to an acid halide, there may be mentioned the method comprising reacting with a phosphorus halide (e.g. phosphorus pentachloride etc.), the method comprising reacting with a thionyl halide (e.g. thionyl chloride etc.), and the like method. As the method of reacting the acid halide with an azide compound, there may be mentioned the method comprising mixing the acid halide and the azide compound (e.g. hydrazoic acid, sodium azide etc.) at a low temperature, and the like method; upon heating to 60 to 150° C., the acid halide can be converted to an isocyanato group. As the method of converting the carboxyl group to an amino group by reaction with an azide compound, there may be mentioned the method comprising reacting with a metal azide (e.g. sodium azide etc.) together with concentrated sulfuric acid, the method comprising heating with diphenyl phosphoroazidate, hydroxamic acid or hydroxylamine hydrochloride, and the like method. As the method of converting the amino group to an isocyanato group, there may be mentioned the methods comprising reacting with phosgene [e.g. the method comprising adding the amine dropwise to a solution of a phosgene species (e.g. phosgene, oxalyl chloride etc.), and the like method], the method comprising reacting with N,N′-carbonyldiimidazole, followed by decomposition at room temperature, the method comprising reacting with carbon monoxide in the presence of a transition metal complex catalyst (e.g. palladium chloride, rhodium chloride, chloroplatinic acid etc.), the method comprising reacting with sodium hypochlorite, sodium hypobromite or the like, followed by alkali treatment, and the like method. As the method of converting a secondary hydroxyl group to a carbonyl group, there may be mentioned the oxidation-based methods [e.g. the method comprising heating in an aqueous alkali solution in the presence of potassium permanganate or the like, the air oxidation method using a platinum catalyst (e.g. platinum-activated carbon, platinum black etc.), the method comprising carrying out the reaction under sulfuric acid-due acidic conditions in the presence of a hexavalent chromium compound or the like and the like method], and the like method. As the method of converting a carbonyl group to an amino group by reacting the carbonyl group with ammonia with simultaneous reduction with hydrogen, there may be mentioned the method comprising carrying out the reaction in the presence of ammonia under pressurization with hydrogen gas in the presence of a hydrogenation catalyst (e.g. Raney nickel, chloroplatinic acid etc.), and the like method. As the method of introducing an amino group into a hydroxyl group, there may be mentioned the method comprising reacting the hydroxyl group with an ethylenimine (e.g. ethylenimine, N-methylethylenimine etc.), and the like method. As the isocyanato group-containing unsaturated compound, there may be mentioned isocyanatomethyl (meth)acrylate, isocyanatomethyl allyl ether and the like.

The non-polyisocyanate-based polymer (NUP) preferably has a Mn of not lower than 500, more preferably not lower than 800, particularly preferably not lower than 1,000, most preferably not lower than 1,200, and preferably not higher than 500,000, more preferably not higher than 100,000, particularly preferably not higher than 10,000, most preferably not higher than 5,000. Within such range, the adhesive strength (in particular wet adhesive strength) becomes higher.

The use of an active hydrogen-containing polymer (B) terminally having a fluorine atom-containing organic group among the non-polyisocyanate-based polymer (NUP) species contributes to an increased level of reactivity of the polymer, hence is preferred. Thus, the terminal structure after conversion to an isocyanato group is preferably represented by —R_{f}—NCO (R_{f}being a perfluoroalkylene group containing 1 to 4 carbon atoms) and/or by —CH(CF₃)—NCO, more preferably by —CH(CF₃)—NCO.

The alkali metal and alkaline earth metal content (in mmol/kg) in the polymer of the invention is preferably 0 or lower than 0.04, more preferably 0 or lower than 0.03, particularly preferably 0 or lower than 0.02, most preferably 0 or lower than 0.01, based on the weight of the polymer. Within such range, the storage stability of the polymer of the invention becomes higher. The alkali metal and alkaline earth metal content in the polymer can be determined by subjecting a 30% (by weight) solution of the polymer in such a solvent as toluene, dimethylformamide or dimethyl sulfoxide, or an aqueous solution prepared by heating and incinerating 10 g of the polymer on a platinum dish and dissolving the ash in 10 g of water, or a like pretreated sample to ion chromatography or by titrating a solution prepared by dissolving 30 g of the polymer in 100 ml of such a solvent as toluene, dimethylformamide or dimethyl sulfoxide with 1/100 N aqueous hydrochloric acid.

From the water-resistant adhesive strength viewpoint, the allophanate/biuret content (in % by weight) (AB content) in the polymer of the invention as expressed on the corresponding isocyanato group content basis is preferably 0 or lower than 0.6, more preferably 0 or lower than 0.4, particularly preferably 0 or lower than 0.2, most preferably 0 or lower than 0.1, on the polymer weight basis. Within such range, the storage stability of the polymer of the invention becomes higher.

In determining the AB content, 100 mg of the sample is added to 5 ml of an anhydrous dimethylformamide solution containing di-n-butylamine (0.1% by weight) and naphthalene (0.1% by weight) and, after 40 minutes of reaction at 70° C., 10 μl of acetic anhydride is added. After the lapse of 10 minutes, the reaction mixture is analyzed by gas chromatography, and the peak area ratio (SA) between di-n-butylacetamide and naphthalene is determined. In a blank run, 100 mg of the sample is added to 5 ml of an anhydrous dimethylformamide solution containing di-n-butylamine (0.1% by weight) and naphthalene (0.1% by weight) and, after 40 minutes of reaction at 25° C., 10 ul of acetic anhydride is added. After the lapse of 10 minutes, the reaction mixture is analyzed by gas chromatography, and the peak area ratio (SB) between di-n-butylacetamide and naphthalene is determined. The AB content is calculated as follows:
AB content (% by weight)=[(SB−SA)/SB]×0.613 (1)

When the polymer of the invention is a tertiary amino group- and/or quaternary ammonio group-containing one, the number of these groups contained therein (in number of groups/g) is preferably not smaller than 1×10¹⁷, more preferably not smaller than 1×10¹⁸, most preferably not smaller than 1×10¹⁹, and preferably not larger than 1×10²³, more preferably not larger than 1×10²², most preferably not larger than 1×10²¹, based on the polymer weight, from the reactivity of the polymer and the like viewpoint. The tertiary amino group- and/or quaternary ammonio group-containing polymer can be obtained by using a tertiary amino group- and/or quaternary ammonio group-containing polyisocyanate (A) and/or active hydrogen-containing polymer (B) as the active hydrogen-containing polymer (B).

The polymer of the invention may optionally contain an active hydrogen-free and isocyanato group-free amine (C) in lieu of a tertiary amino group and/or quaternary ammonio group in the polymer. When it contains (C), the adhesive strength (in particular initial adhesive strength) becomes better.

Employable as the active hydrogen-free, isocyanato group-free amine (C) are tertiary amines (C1), quaternary ammonium salts (C2), and the like.

As the tertiary amine (C1), there may be mentioned amines containing 1 to 36 carbon atoms, including aliphatic amines, alicyclic amines, heterocyclic amines, aromatic ring-containing aliphatic amines, aromatic amines and the like. As the aliphatic amines, there may be mentioned aliphatic monoamines (trimethylamine, triethylamine, tripropylamine, trihexylamine, tridecylamine, N-methyldicyclohexylamine, N,N-dimethylcyclohexylamine, N-methyl-N,N-bis(3-dimethylaminopropyl)amine, N,N-dimethyleicosylamine, etc.), aliphatic polyamines [N,N,N-tris(3-dimethylaminopropyl)amine, tetraalkylalkylenediamines (N,N,N,N-tetramethylethylenediamine, N,N,N,N-tetraethylpropylenediamine, N,N,N,N-tetraethylundecylenediamine, etc.), polyalkylpolyalkylenepolyamines (pentamethyldiethylenetriamine, pentaethyldipropylenetriamine, hexamethyltriethylenetetramine, octamethylpentaethylenehexamine, etc.) etc.], and the like. As the alicyclic amines, there may be mentioned alicyclic monoamines (tricyclohexylamine, N,N-dimethylisophoronemonoamine, N,N-dimethyl-4-cyclohexylmethylcyclohexylamine, N,N-diethyl-4-dicyclohexylmethylcyclohexylamine, etc.), alicyclic polyamines (tetramethyl-1,3-diaminocyclohexane etc.), and the like. As the heterocyclic amines, there may be mentioned heterocyclic monoamines (N-methylpiperidine, N-dimethylaminoethylpyridine, pyridine, quinoline, N-methylmorpholine, N-methyl-2,6-dimethylmorpholine, etc.), heterocyclic polyamines [N,N′,N″-tris(dimethylaminopropyl)hexahydrotriazine, N,N′-dimethylpiperazine, 1,4-bis(dimethylaminoethyl)piperazine, pyridazine, pyrimidine, methylpurine, diazabicycloundecene, diazabicyclononene, bis(morpholinoethyl) ether, bis(morpholinopropyl) ether, bis(2,6-dimethylmorpholinoethyl) ether, 1,2-bis(2,6-dimethylmorpholinoethoxy)ethane, bis(2,6-dimethylmorpholinoethoxyethyl) ether, 2,2′-bis(2,6-dimethylmorpholinoethoxyethyl)diethyl ether, etc.], and the like. As the aromatic ring-containing aliphatic amines, there may be mentioned N,N-dimethylaminomethylbenzene, tetramethylxylylenediamine and the like, and as the aromatic amines, there may be mentioned N,N-dimethylaniline, tetramethylphenylenediamine and the like.

Employable as the quaternary ammonium salts (C2) are those ones having a structure resulting from quaternization of the amino group(s) of (C1) with a quaternizing agent, and the like, and there may be mentioned aliphatic ammonium salts (tetramethylammonium carbonate etc.); alicyclic ammonium salts (methyltricyclohexylammonium methyl sulfate etc.); heterocyclic ammonium salts (N,N-dimethylpiperidinium carbonate, N,N-dimethyl-2,6-dimethylmorpholinium carbonate, etc.); aromatic ring-containing aliphatic ammonium salts (N,N,N-trimethylammoniummethylbenzene chloride etc.); aromatic ammonium salts (N,N,N-trimethylanilinium carbonate etc.); aliphatic polyammonium salts [hexaalkylalkylenediammonium salts (N,N,N,N′,N′,N′-hexamethylethylenediamine dicarbonate etc.), polyalkylpolyalkylenepolyammonium salts (heptamethyldiethylenetriamine tricarbonate) etc.]; alicyclic polyammonium salts (tetramethyl-1,3-diammoniumcyclohexane dichloride etc.); heterocyclic polyammonium salts (N,N,N′,N′-tetramethylpiperazinium dicarbonate etc.); aromatic ring-containing aliphatic polyammonium salts (hexamethylxylylenediammonium dichloride etc.); aromatic polyammonium salts (hexamethylphenylenediammonium dichloride etc.); and the like.

Preferred among these are aliphatic amines, alicyclic amines, heterocyclic amines, and quaternary ammonium carbonate salts derived from these. More preferred are aliphatic amines, heterocyclic amines, and quaternary ammonium carbonate salts derived from these. Particularly preferred are heterocyclic polyamines. Most preferred are morpholine ring-containing heterocyclic polyamines.

When the active hydrogen-free and isocyanato group-free amine (C) is used, the content (in % by weight) of (C) in the polymer of the invention is preferably not lower than 0.05, more preferably not lower than 0.1, most preferably not lower than 0.5, and preferably not larger than 20, more preferably not larger than 10, most preferably not larger than 5, based on the weight of the polymer. Within such range, the adhesive strength (in particular initial adhesive strength) becomes higher. The content of (C) in the polymer can be determined by treating the polymer with methanol or the like for reaction with the isocyanato groups, followed by analysis by gas chromatography, liquid chromatography or the like. The method of incorporating (C) is not particularly restricted. For example, the method comprising adding (C) to the polymer reaction apparatus before (including during) or after polymer synthesis, followed by mixing up, the method comprising adding (C) to the adhesive comprising the polymer of the invention just prior to use of the adhesive, followed by mixing up, or the like method.

Among the polymers of the invention, as the one having an epoxy group (e.g. glycidyl group, 2,3-oxacyclohexyl group etc.) as the reactive functional group, there may be mentioned one (EP) having at least one epoxy group in each molecule, and the like. (EP) can be obtained by reacting the above-mentioned active hydrogen-containing polymer (B) with an epoxy group-containing compound, and by the like method. As the epoxy group-containing compound, there may be mentioned epichlorohydrin, 2,3-oxacyclohexyl chloride, allyl glycidyl ether, isocyanatoethyl glycidyl ether and the like. Among them, epichlorohydrin and 2,3-oxacyclohexyl chloride are preferred from the ease of reaction viewpoint, and epichlorohydrin is most preferred.

Among the polymers of the invention, as the one having a (meth)acryloyl group as the reactive functional group, there may be mentioned one (MA) having at least one (meth)acryloyl group in each molecule, and the like. (MA) can be obtained by reacting the above-mentioned active hydrogen-containing polymer (B) with a (meth)acryloyl group-containing compound, and by the like method. As the (meth)acryloyl group-containing compound, there may be mentioned (meth)acrylic acid, (meth)acrylic chloride, glycidyl (meth)acrylate, isocyanatoethyl (meth)acrylate and the like. Among these, (meth)acrylic acid and glycidyl (meth)acrylate are preferred from the ease of reaction viewpoint, and glycidyl (meth)acrylate is most preferred.

Among the polymers of the invention, as the one having a cyano(meth)acryloyl group as the reactive functional group, there may be mentioned one (CMA) having at least one cyano(meth)acryloyl group in each molecule, and the like. (CMA) can be obtained by reacting the above-mentioned active hydrogen-containing polymer (B) with a cyano(meth)acryloyl group-containing compound, and by the like method. As the cyano(meth)acryloyl group-containing compound, there may be mentioned cyano(meth)acrylic acid, cyano(meth)acrylic chloride, glycidyl cyano(meth)acrylate, isocyanatocyanoethyl (meth)acrylate, and the like. Among these, cyano(meth)acrylic acid and glycidyl cyano(meth)acrylate are preferred from the ease of reaction viewpoint, and glycidyl cyano(meth)acrylate is most preferred.

Among the polymers of the invention, as the one having an alkoxysilyl group (e.g. trimethoxysilyl group, triethoxysilyl group etc.) as the reactive functional group, there may be mentioned one (AS) having at least one alkoxysilyl group in each molecule, and the like. The polymer (AS) can be obtained by reacting the active hydrogen-containing polymer (B) mentioned above with an alkoxysilyl group-containing compound, and by the like method. As the alkoxysilyl group-containing compound, there may be mentioned alkoxysilyl chlorides (trimethoxysilyl chloride, methyldimethoxysilyl chloride, triethoxysilyl chloride, etc.), alkoxysilyl glycidyl ethers (trimethoxysilyl glycidyl ether, methyldimethoxymethyl glycidyl ether, triethoxysilyl glycidyl ether, etc.), and the like. Among these, alkoxysilyl chlorides and alkoxysilyl glycidyl ethers are preferred from the ease of reaction viewpoint, and alkoxysilyl glycidyl ethers are most preferred.

One or more other ingredients as necessary may further be incorporated in the polymer of the invention. As the other ingredients, there may be mentioned physiologically active medicinals (central nervous system drugs, antiallergic drugs, circulatory organ drugs, respiratory organ drugs, digestive organ drugs, hormones, metabolic drugs, carcinostatic drugs, antibiotic preparations, chemotherapeutic agents, etc.), fillers (carbon black, red iron oxide, calcium silicate, sodium silicate, titanium oxide, acrylic resin powders, various ceramic powders, etc.), plasticizers (DBP, DOP, TCP, tributoxyethyl phosphate, various other esters, etc.), stabilizers (trimethyldihydroquione, phenyl-p-naphthylamine, p-isopropoxydiphenylamine, diphenyl-p-phenylenediamine, etc.), and the like. When such an ingredient or ingredients are incorporated, the level of addition (in % by weight) thereof is preferably not lower than 0.001, more preferably not lower than 0.1, and preferably not larger than 20, more preferably not larger than 5, based on the weight of the polymer of the invention.

A compound (D) having a polymerizable double bond with a cyano group bound to either of the double bond-forming carbon atoms may be incorporated in the polymer of the invention for providing more rapid curability. As such compound (D), there may be mentioned cyano(meth)acrylic 30 acid, methyl cyano(meth)acrylate, cyano(meth)acrylamide (Japanese Kokai Publication Hei-01-227762), and the like.

When such a compound (D) is used, the usage (in % by weight) of (D) is preferably not lower than 0.001, more preferably not lower than 0.1, and preferably not larger than 50, more preferably not larger than 20, based on the weight of the polymer.

In the presence of a trace amount of water or of moisture in the air, the polymer of the invention undergoes rapid polymerization to form a firm and strong film. Therefore, the other ingredient or ingredients to be incorporated therein are required to be free of water/moisture. When put in a tightly closed vessel or container (e.g. ampoule etc.), the polymer of the invention as produced can be stored for a long period. The storage temperature (in ° C.) is preferably not lower than −200, more preferably not lower than −100, most preferably not lower than 80, and preferably not higher than 100, more preferably not higher than 50, most preferably not higher than 30.

The polymer of the invention is suited for use in preventing fluid leakage from vital tissues and/or in adhesion of vital tissues, hence is suited for use as a medical adhesive. In particular, the polymer of the invention provides a high level of water-resistant adhesive strength and, therefore, can preferably be used in adhering vital tissues, such as liver, kidney, spleen, pancreas, heart, lung, blood vessels (artery, vein, capillary vessel, etc.), trachea, bronchus, digestive tracts (esophagus, stomach, duodenum, small intestine, large intestine, rectum, etc.) and nerves, stopping bleeding, prevention of contents, enzyme, digestive juices or the like fluid from leaking from digestive organs and the like, temporary fixation prior to suture, reinforcing joints (sites of suture and sites of anastomosis) etc., and the like. Among the vital tissues, those tissues which are flexible and move actively, for example lung, blood vessels, heart and the like tissue, are the suitable targets of application of the polymer, and liver and lung are the best suited targets. The medical adhesive which comprises the polymer of the invention is effective not only in adhering vital tissues but also in other fields of application, for example as a coating material for aneurysms/phlebeurysms and the like, as a sealing material, as a conglutination preventing agent for use on the occasion of surgical, operation, and the like. Furthermore, it can be effectively used in joining wound faces, incised wound faces and the like, and in adhering treatment in dental surgery as well.

As for the method of adhering using the medical adhesive which comprises the polymer of the invention in surgical operations, there may be mentioned the direct adhesion method comprising directly applying the adhesive to the site of cutting; the transfer adhesion method comprising applying the adhesive to a highly releasable film such as a silicone film or fluoroplastic film, covering the site of cutting with the adhesive together with the film and, after reaction, removing the film; the covering adhesion method comprising attaching a vital tissue section, such as a vein, fascia or muscle, together with a cloth or nonwoven cloth made of Dacron, oxidized cellulose, collagen, chitin, polyurethane, polyester, PVA or the like, to the affected part and applying the adhesive thereto; the suture fixation method comprising stitching up a part of the vital tissue joint with a suture and applying the adhesive to the remaining part of the joint in the manner of sealing; and the like method.

As for the method of application, there may be mentioned the method using a writing brush, tweezers, a spatula or the like, the spray method using Freon or nitrogen gas, and the like method.

### BEST MODE FOR CARYYING OUT THE INVENTION

The following examples are further illustrative of the present invention. These examples are, however, by no means limitative of the scope of the invention. Unless otherwise specified, “part(s)” means “part(s) by weight”.

### PRODUCTION EXAMPLE 1

An autoclave was charged with 15.5 parts of ethylene glycol and 3.8 parts of potassium hydroxide and, after replacement with nitrogen, the contents were dehydrated under vacuum at 120° C. for 60 minutes. Then, a mixture of 784.5 parts of ethylene oxide and 200 parts of propylene oxide was charged into the autoclave under pressure at 100 to 130° C. over about 10 hours. The reaction was allowed to proceed at 130° C. until the volatile matter content amounted to 0.1% or below. Thus was obtained a crude polyether (c-EPRA) with an oxyethylene group content of 80%.

### PRODUCTION EXAMPLE 2

An autoclave was charged with 1,000 parts of the crude polyether (c-EPRA), the oxygen concentration in the gaseous phase was reduced to 450 ppm by replacement with nitrogen, 30 parts of deionized water was added, 10 parts of synthetic magnesium silicate (sodium content: 0.2%) was then added, the oxygen concentration in the gaseous phase was maintained at 450 ppm by replacement with nitrogen, and the contents were stirred at a stirring rate of 300 rpm at 90° C. for 45 minutes. Then, the reaction mixture was filtered through a glass filter (GF-75; product of Toyo Roshi Kaisha, Ltd.) under nitrogen to give an ethylene oxide/propylene oxide random copolymer (EPRAl). The oxyethylene group content of EPRAl was 80%, the alkali metal and/or alkaline earth metal content was 0.02 mmol/kg, and the Mn was 4,000.

### PRODUCTION EXAMPLE 3

An autoclave was charged with 1,000 parts of the crude polyether (c-EPRA), and the oxygen concentration in the gaseous phase was reduced to 450 ppm by replacement with nitrogen. In a separate vessel, 30 parts of deionized water and 8 parts of synthetic magnesium silicate (sodium content: 0.2%) were mixed up and deoxygenated, and the mixture was added to the autoclave. The oxygen concentration in the gaseous phase was measured and, after confirmation that it was 450 ppm, the contents were stirred at a stirring rate of 300 rpm at 90° C. for 90 minutes. Then, the reaction mixture was filtered through a glass filter (GF-75; product of Toyo Roshi Kaisha, Ltd.) under nitrogen to give an ethylene oxide/propylene oxide random copolymer (EPRA2). The oxyethylene group content of EPRA2 was 80%, the alkali metal and/or alkaline earth metal content was 0.04 mmol/kg, and the Mn was 4,000.

### PRODUCTION EXAMPLE 4

An autoclave was charged with 1,000 parts of the crude polyether (c-EPRA), the oxygen concentration in the gaseous phase was reduced to 450 ppm by replacement with nitrogen, 30 parts of deionized water was added, 12 parts of magnesium silicate (sodium content: 3% by weight) was then added, the oxygen concentration in the gaseous phase was adjusted to 450 ppm by replacement with nitrogen, and the contents were stirred at a stirring rate of 300 rpm at 90° C. for 240 minutes. Then, the reaction mixture was filtered through a glass filter (GF-75; product of Toyo Roshi Kaisha, Ltd.) under nitrogen to give an ethylene oxide/propylene oxide random copolymer (EPRA3). The oxyethylene group content of EPRA3 was 80%, the alkali metal and/or alkaline earth metal content was 0.08 mmol/kg, and the Mn was 4,000.

### PRODUCTION EXAMPLE 5

An autoclave was charged with 320 parts of propylene glycol and 3.8 parts of potassium hydroxide and, after replacement with nitrogen, the contents were dehydrated under vacuum at 120° C. for 60 minutes. Then, 680 parts of propylene oxide was charged into the autoclave under pressure at 100 to 130° C. over about 10 hours. The reaction as allowed to proceed at 130° C. until the volatile matter content amounted to 0.1% or below. Thus was obtained a crude polyether (c-PA).

### PRODUCTION EXAMPLE 6

An autoclave was charged with 1,000 parts of the crude polyether (c-PA), the oxygen concentration in the gaseous phase was reduced to 450 ppm by replacement with nitrogen, 30 parts of deionized water was added, 10 parts of synthetic magnesium silicate (sodium content: 0.2%) was then added, the oxygen concentration in the gaseous phase was maintained at 450 ppm by replacement with nitrogen, and the contents were stirred at a stirring rate of 300 rpm at 90° C. for 45 minutes. Then, the reaction mixture was filtered through a glass filter (GF-75; product of Toyo Roshi Kaisha, Ltd.) under nitrogen to give a propylene oxide polymer (PAl). The oxyethylene group content of PAl was 0%, the alkali metal and/or alkaline earth metal content was 0.03 mmol/kg, and the Mn was 200.

### PRODUCTION EXAMPLE 7

An autoclave was charged with 1,000 parts of the crude polyether (c-PA), the oxygen concentration in the gaseous phase was reduced to 450 ppm by replacement with nitrogen, 30 parts of deionized water was added, 12 parts of magnesium silicate (sodium content: 3%) was then added, the oxygen concentration in the gaseous phase was maintained at 450 ppm by replacement with nitrogen, and the contents were stirred at a stirring rate of 300 rpm at 90° C. for 240 minutes. Then, the reaction mixture was filtered through a glass filter (GF-75; product of Toyo Roshi Kaisha, Ltd.) under nitrogen to give a polypropylene glycol species (PA2). The oxyethylene group content of PA2 was 0%, the alkali metal and/or alkaline earth metal content was 0.08 mmol/kg, and the Mn was 200.

### PRODUCTION EXAMPLE 8

An autoclave was charged with 22.0 parts of dimethylaminoethylamine and, after replacement with nitrogen, a mixture of 400 parts of ethylene oxide and 78 parts of propylene oxide was introduced under pressure at 100 to 130° C. over about 3 hours. The reaction was allowed to proceed at 130° C. for 3 hours. To the reaction mixture was added 3.8 parts of potassium hydroxide and, after replacement with nitrogen, the contents were dehydrated under vacuum at 120° C. for 60 minutes. Then, a mixture of 400 parts of ethylene oxide and 100 parts of propylene oxide was charged into the autoclave under pressure at 100 to 130° C. over about 7 hours, and the reaction was allowed to proceed at 130° C. for 5 hours to give a crude polyether (c-3AEPRA). To this crude polyether (c-3AEPRA) was added 30 parts of deionized water, 10 parts of magnesium silicate (sodium content: 0.2% by weight) was then added, the oxygen concentration in the gaseous phase was adjusted to 450 ppm or below by replacement with nitrogen, and the contents were stirred at a stirring rate of 300 rpm at 90° C. for 45 minutes. Then, the reaction mixture was filtered through a glass filter (GF-75; product of Toyo Roshi Kaisha, Ltd.) under nitrogen to give a tertiary amino group-containing ethylene oxide/propylene oxide random copolymer (3AEPRA). The oxyethylene group content of 3AEPRA was 80%, the alkali metal and/or alkaline earth metal content was 0.02 mmol/kg, the tertiary amino group content was 3.0×10²⁰ groups/g, and the Mn was 4,000.

### PRODUCTION EXAMPLE 9

An autoclave was charged with 60.5 parts of N,N,N′,N′-tetramethyethylenediammonium bisnitrate and, after replacement with nitrogen, a mixture of 400 parts of ethylene oxide and 39.5 parts of propylene oxide was introduced under pressure at 100 to 130° C. over about 3 hours. The reaction was allowed to proceed at 130° C. for 3 hours. To the reaction mixture was added 3.8 parts of potassium hydroxide and, after replacement with nitrogen, the contents were dehydrated under vacuum at 120° C. for 60 minutes. Then, a mixture of 400 parts of ethylene oxide and 100 parts of propylene oxide was charged into the autoclave under pressure at 100 to 130° C. over about 7 hours, and the reaction was allowed to proceed at 130° C. for 5 hours to give a crude polyether (c-4AEPRA). The subsequent treatment was carried out in the same manner as in Production Example 2 to give a quaternary ammonio group-containing ethylene oxide/propylene oxide random copolymer (4AEPRA). The oxyethylene group content of 4AEPRA was 80%, the alkali metal and/or alkaline earth metal content was 0.02 mmol/kg, the quaternary ammonio group content was 3.1×10²⁰ groups/g, and the Mn was 4,000.

### PRODUCTION EXAMPLE 10

27.8 parts of epichlorohydrin and 2.22 parts of benzyltrimethylammonium chloride were admixed with 1,112 parts of c-EPRA obtained in Production Example 1, and 58.9 parts of sodium hydroxide in granular form was added over 5 hours while maintaining the temperature at 30° C. or below, followed by 3 hours of maturation at 30° C. The remaining epichlorohydrin was distilled off under reduced pressure, 33.4 parts of deionized water and 111 parts of magnesium silicate (sodium content: 0.2% by weight) were then added, and the mixture was stirred at 90° C. for 45 minutes. Then, the reaction mixture was filtered through a glass filter (GF-75; product of Toyo Roshi Kaisha, Ltd.) under nitrogen to give an epoxidized product (EP-EPRA). An autoclave after replacement with nitrogen was charged with 800 parts of methanol and 20 parts of triethylamine, a solution of 1,112 parts of EP-EPRA in 800 parts of methanol and 10 parts of hydrogen sulfide were charged with stirring through respective separate charging inlets while maintaining the reaction temperature at 25° C. and the pressure at 4 kg/cm². After charging, the mixture was matured at that temperature for 3 hours, and the residual hydrogen sulfide in the vessel was eliminated by introducing into 30% aqueous sodium hydroxide by bubbling nitrogen into the mixture. Furthermore, while bubbling nitrogen into the liquid, the methanol and triethylamine were distilled off at 100° C. and 20 mm Hg over 4 hours to give a mercapto group-containing ethylene oxide/propylene oxide random copolymer (SEPRA). The oxyethylene group content of SEPRA was 80%, the alkali metal and/or alkaline earth metal content was 0.02 mmol/kg, and the Mn was 4,000.

### PRODUCTION EXAMPLE 11

A mercapto group-containing polypropylene glycol (SPA) was obtained in the same manner as in Production Example 10 except that 55.6 parts of c-PA obtained in Production Example 5 was used in lieu of 1,112 parts of c-EPRA. The oxyethylene group content of SEPRA was 0%, the alkali metal and/or alkaline earth metal content was 0.03 mmol/kg, and the Mn was 200.

### PRODUCTION EXAMPLE 12

An autoclave was charged with 15.5 parts of ethylene glycol and 3.8 parts of potassium hydroxide and, after replacement with nitrogen, a mixture of 784.5 parts of ethylene oxide and 190 parts of propylene oxide was introduced under pressure at 100 to 130° C. over about 10 hours. The reaction was allowed to proceed at 130° C. for 8 hours, 10 parts of 3,3,3-trifluoropropylene oxide was added under pressure, and the reaction was allowed to proceed at 130° C. for 5 hours to give a crude fluorine-containing polyether (c-EPRFA). To 1,000 parts of the crude polyether (c-EPRFA) was added 30 parts of deionized water, followed by addition of 10 parts of magnesium silicate (sodium content: 0.2% by weight). After adjustment of the oxygen concentration in the gaseous phase to 450 ppm by replacement with nitrogen, the contents were stirred at a stirring rate of 300 rpm at 90° C. for 45 minutes. Then, the reaction mixture was filtered through a glass filter (GF-75; product of Toyo Roshi Kaisha, Ltd.) under nitrogen to give a fluorine-containing ethylene oxide/propylene oxide random copolymer (EPRFA). The oxyethylene group content of EPRFA was 80%, the alkali metal and/or alkaline earth metal content was 0.02 mmol/kg, and the Mn was 4,000.

### PRODUCTION EXAMPLE 13

An autoclave was charged with 320 parts of propylene glycol and 3.8 parts of potassium hydroxide and, after replacement with nitrogen, the charge was dehydrated under vacuum at 120° C. for 60 minutes. Then, at 100 to 130° C., 670 parts of propylene oxide was introduced under pressure over about 10 hours. The reaction was allowed to proceed at 130° C. for 8 hours. Then, 10 parts of 3,3,3-trifluoropropylene oxide was introduced under pressure, and the reaction was allowed to proceed at 130° C. for 5 hours to give a crude fluorine-containing polyether (c-PFA). The subsequent treatment was carried out in the same manner as in Production Example 12 to give a fluorine-containing polypropylene glycol (PFA). The oxyethylene group content of PFA was 0%, the alkali metal and/or alkaline earth metal content was 0.03 mmol/kg, and the Mn was 200.

### EXAMPLE 1

400 parts of (EPRAl) obtained in Production Example 2 was dehydrated under reduced pressure at 90° C. for 8 hours, 93.6 parts of OCN—CH₂(CF₂)₄CH₂—NCO (NCO group/OH group ratio: 3/1) was added at 25° C. and, after attaining homogeneity by stirring, the temperature was raised to 80° C. over 30 minutes, and the reaction was allowed to proceed at 80° C. for 8 hours to give a urethane prepolymer (UP1). During reaction, no abnormal viscosity increase was observed, and the NCO content of (UP1) was the same as the theoretical value.

### EXAMPLE 2

A mixture of 124.1 parts of (EPRA1) obtained in Production Example 2 and 13.8 parts of (PA2) obtained in Production Example 7 was dehydrated under reduced pressure at 90° C., 42.4 parts of OCN—CH₂(CF₂)₂CH₂—NCO (NCO group/OH group ratio: 2/1) was then added at 25° C. and, after attaining homogeneity by stirring, the temperature was raised to 80° C. over 30 minutes, and the reaction was allowed to proceed at 80° C. for 8 hours to give a urethane prepolymer (UP2). During reaction, no abnormal viscosity increase was observed, and the NCO content of (UP2) was the same as the theoretical value.

### EXAMPLE 3

A mixture of 124.1 parts of (EPRA2) obtained in Production Example 3 and 13.8 parts of (PA2) obtained in Production Example 7 was dehydrated under reduced pressure at 90° C., 82.4 parts of OCN—CH₂(CF₂)₆CH₂—NCO (NCO group/OH group ratio: 2/1) was then added at 25° C. and, after attaining homogeneity by stirring, the temperature was raised to 80° C. over 30 minutes, and the reaction was allowed to proceed at 80° C. for 8 hours to give a urethane prepolymer (UP3). During reaction, no abnormal viscosity increase was observed, and the NCO content of (UP3) was slightly lower than the theoretical value.

### EXAMPLE 4

A mixture of 194.9 parts of (EPRA1) obtained in Production Example 2 and 10.3 parts of (PA2) obtained in Production Example 7 was dehydrated under reduced pressure at 90° C., 34.8 parts of tolylene diisocyanate (TDI) (NCO group/OH group ratio: 2/1) was then added at 25° C. and, after attaining homogeneity by stirring, the temperature was raised to 80° C. over 30 minutes, and the reaction was allowed to proceed at 80° C. for 8 hours to give a urethane prepolymer (UP4).

### EXAMPLE 5

The unreacted TDI was removed from (UP4) obtained in Example 4 by raising to 120° C. under reduced pressure and maintaining the reduced pressure (1 mm Hg) for 8 hours to give a urethane prepolymer (UP5).

### EXAMPLE 6

100 parts of (UP4) obtained in Example 4 was heated to 80° C., 4.8 parts of (PA2) obtained in Production Example 7 was added dropwise thereto over 90 minutes, and the reaction was further allowed to proceed at 80° C. for 90 minutes to give a urethane prepolymer (UP6).

### EXAMPLE 7

A mixture of 124.1 parts of (EPRAl) obtained in Production Example 2 and 13.8 parts of (PA2) obtained in Production Example 7 was dehydrated under reduced pressure at 90° C., 50.0 parts of diphenylmethanediisocyanate (MDI) (NCO group/OH group ratio: 2/1) was then added at 25° C. and, after attaining homogeneity by stirring, the temperature was raised to 80° C. over 30 minutes, and the reaction was allowed to proceed at 80° C. for 8 hours to give a urethane prepolymer (UP7).

### EXAMPLE 8

The unreacted MDI was removed from (UP7) obtained in Example 7 by raising the temperature to 120° C. under reduced pressure and maintaining the reduced pressure (1 mm Hg) for 12 hours while bubbling a minute amount of nitrogen through the liquid phase, to give a urethane prepolymer (UP8).

### EXAMPLE 9

A mixture of 194.9 parts of (3AEPRA) obtained in Production Example 8 and 10.3 parts of (PA2) obtained in Production Example 7 was dehydrated under reduced pressure at 90° C., 33.6 parts of hexamethylene diisocyanate (HDI) (NCO group/OH group ratio: 2/1) was then added at 25° C. and, after attaining homogeneity by stirring, the temperature was raised to 80° C. over 30 minutes, and the reaction was allowed to proceed at 80° C. for 8 hours to give a urethane prepolymer (UP9)

### EXAMPLE 10

A urethane prepolymer (UP10) was obtained in the same manner as in Example 9 except that 44.4 parts of isophoronediisocyanate (IPDI) was used in lieu of 33.6 parts of hexamethylene diisocyanate (HDI).

### EXAMPLE 11

A urethane prepolymer (UP11) was obtained in the same manner as in Example 9 except that (4AEPRA) obtained in Production Example 9 was used in lieu of (3AEPRA).

### EXAMPLE 12

A urethane prepolymer (UP12) was obtained in the same manner as in Example 9 except that a mixture of 97.5 parts of (EPRA3) obtained in Production Example 4 and 97.4 parts of (EPRAL) obtained in Production Example 2 was used in lieu of (3AEPRA).

### EXAMPLE 13

A mixture of 194.9 parts of (EPRA1) obtained in Production Example 2 and 10.3 parts of (PA2) obtained in Production Example 7 was dehydrated under reduced pressure at 90° C., 33.6 parts of hexamethylene diisocyanate (HDI) (NCO group/OH group ratio: 2/1) was then added at 25° C. and, after attaining homogeneity by stirring, the temperature was raised to 80° C. over 30 minutes, and the reaction was allowed to proceed at 80° C. for 14 hours to give a urethane prepolymer (UP13).

### EXAMPLE 14

A urethane prepolymer (14) was obtained by mixing up 100 parts by weight of (UP13) obtained in Example 13 and 0.6 parts by weight of diazabicycloundecene.

### EXAMPLE 15

A urethane prepolymer (15) was obtained by mixing up 100 parts by weight of (UP13) obtained in Example 13 and 5 parts by weight of bis(2,6-dimethylmorpholinoethyl) ether.

### EXAMPLE 16

A urethane prepolymer (16) was obtained by mixing up 100 parts by weight of (UP13) obtained in Example 13 and 0.6 parts by weight of N,N′,N″-tris(dimethylaminopropyl)hexahydrotriazine.

### EXAMPLE 17

A urethane prepolymer (17) was obtained by mixing up 100 parts by weight of (UP13) obtained in Example 13 and 2 parts by weight of N,N,N′,N′-tetramethylpiperazinium dicarbonate.

### EXAMPLE 18

A urethane prepolymer (UP18) was obtained in the same manner as in Example 13 except that 44.4 parts of isophoronediisocyanate (IPDI) was used in lieu of 33.6 parts of hexamethylene diisocyanate (HDI).

### EXAMPLE 19

A urethane prepolymer (19) was obtained by mixing up 100 parts by weight of (UP18) obtained in Example 18 and 0.6 parts by weight of diazabicycloundecene.

### EXAMPLE 20

400 parts of (SEPRA) obtained in Production Example 10 was dehydrated under reduced pressure at 90° C. for 8 hours, 93.6 parts of OCN—CH₂(CF₂)₄CH₂—NCO (NCO group/OH group ratio: 3/1) was added at 25° C. and, after attaining homogeneity by stirring, the temperature was raised to 80° C. over 30 minutes, and the reaction was allowed to proceed at 80° C. for 8 hours to give a urethane prepolymer (UP20).

### EXAMPLE 21

A mixture of 124.1 parts of (SEPRA) obtained in Production Example 10 and 13.8 parts of (SPA) obtained in Production Example 11 was dehydrated under reduced pressure at 90° C. for 8 hours, 62.4 parts of OCN—CH₂(CF₂)₄CH₂—NCO (NCO group/OH group ratio: 2/1) was then added at 25° C. and, after attaining homogeneity by stirring, the temperature was raised to 80° C. over 30 minutes, and the reaction was allowed to proceed at 80° C. for 8 hours to give a urethane prepolymer (UP21).

### EXAMPLE 22

10 parts of platinum black was added to 100 parts of (EPRFA) obtained in Production Example 12, and the reaction was allowed to proceed at 60° C. with stirring for 10 hours while passing air through the gaseous phase. The reaction mixture was filtered through a glass filter (GF-75; product of Toyo Roshi Kaisha, Ltd.) to give a polyether having carbonyl groups introduced therein. Then, 10 parts of ammonia was introduced under pressure, the reaction was allowed to proceed at 25° C. for 2 hours, 1 part of Raney nickel was then added, and the reaction system was pressurized to 90 atm with hydrogen gas at 25° C. The temperature was gradually raised, and the reaction was allowed to proceed at 40° C. for 5 hours and then at 70° C. for 5 hours. The excess ammonia, hydrogen and the byproduct water were removed under reduced pressure, and the remaining reaction mixture was filtered through a glass filter (GF-75; product of Toyo Roshi Kaisha, Ltd.) to give a polyether having amino groups introduced therein. To this was added 0.5 parts of palladium chloride and, while passing carbon monoxide through the mixture, the reaction was allowed to proceed at 65° C. for 3 days. The excess carbon monoxide was removed under reduced pressure, and the reaction mixture was filtered through a glass filter (GF-75; product of Toyo Roshi Kaisha, Ltd.) to give a polymer (NUPL) resulting from conversion of the terminal functional groups to isocyanato groups.

### EXAMPLE 23

The procedure of Example 22 was followed in the same manner except that a mixture of 95 parts of the random copolymer (EPRFA) obtained in Production Example 12 and 5 parts of (PFA) obtained in Production Example 13 was used in lieu of 100 parts of (EPRFA), to give a polymer (NUP2) resulting from conversion of the terminal functional groups to isocyanato groups.

### COMPARATIVE EXAMPLE 1

400 parts of (EPRA3) obtained in Production Example 4 was dehydrated under reduced pressure at 90° C., 93.6 parts of OCN—CH₂(CF₂)₄CH₂—NCO (NCO group/OH group ratio: 3/1) was then added at 25° C. and, after attaining homogeneity by stirring, the temperature was raised to 80° C. over 30 minutes, and the reaction was allowed to proceed at 80° C. for 8 hours to give a comparative urethane prepolymer (HUP1).

### COMPARATIVE EXAMPLE 2

A mixture of 124.1 parts of (EPRA3) obtained in Production Example 4 and 13.8 parts of (PA2) obtained in Production Example 7 (the alkali metal and alkaline earth metal content in the mixture: 0.08 mmol/kg) was dehydrated under reduced pressure at 90° C., 82.4 parts of OCN—CH₂(CF₂)₆CH₂—NCO (NCO group/OH group ratio: 2/1) was then added at 25° C. and, after attaining homogeneity by stirring, the temperature was raised to 80° C. over 30 minutes, and the reaction was allowed to proceed at 80° C. for 8 hours to give a comparative urethane prepolymer (HUP2).

### COMPARATIVE EXAMPLE 3

A mixture of 2.2 parts of (EPRAL) obtained in Production Example 2 and 19.9 parts of (PA1) obtained in Production Example 6 was dehydrated under reduced pressure at 90° C., 82.4 parts of OCN—CH₂(CF₂)₆CH₂—NCO (NCO group/OH group ratio: 2/1) was then added at 25° C. and, after attaining homogeneity by stirring, the temperature was raised to 80° C. over 30 minutes, and the reaction was allowed to proceed at 80° C. for 8 hours to give a comparative urethane prepolymer (HUP3).

### COMPARATIVE EXAMPLE 4

A comparative urethane prepolymer (HUP4) was obtained in the same manner as in Comparative Example 3 except that 20.0 parts of (PA1) was used in lieu of the mixture of 2.2 parts of (EPRA1) and 19.9 parts of (PA1).

Each polymer was evaluated for the following items, and the results thus obtained are shown in Table 1 and Table 2.

<Viscosity>

Viscosity measurements were made using a DA viscometer according to the method D prescribed in JIS K 7117-1987.

<Saturated Water Absorption>

Using an apparatus for D/W method of testing for water absorption rates (buret capacity: 25 ml, length: 55 cm, testing solution: physiological saline, small opening diameter: 2 mm) as shown in JIS K 7224-1996- Illustration 1, measurements were carried out in a room maintained at 25° C. and 50% humidity with Whatman's glass microfiber filter GF/A having a diameter of 3.7 cm installed in lieu of the nonwoven fabric, together with a polycarbonate cylinder having an inside diameter of 3.7 cm, and the water absorption 30 minutes after setting of 1.0 g of each polymer was read.

<Initial Water Absorption Rate>

In the same manner as in the saturated water absorption measurement, the water absorption 2 minutes after setting was measured and the value was multiplied by 1/2.

<Wet Elongation Percentage>

Test specimens prepared by applying the polymer onto a glass plate to a size of 10 cm square and a thickness of about 100 um using an applicator, allowing the coating to stand at 25° C. and 50% RH for 48 hours for attaining curing, allowing the same to stand in a physiological saline bath at 25° C. and, after 24 hours, taking out the same, and stamping out of the same using a No. 3 dumbbell-shaped die described in JIS K 6251-1993 were kept in physiological saline for 1 hour, deprived of moisture with gauze, precisely measured for thickness and, within 5 minutes, tested for elongation at break at a rate of pulling of 300 mm/min in an atmosphere of 25° C. and 50% RH according to JIS K 6251-1993. The tensile testing machine used was Shimadzu Corp's model AGS-500B autograph.

<Wet 100% Modulus>

Simultaneously with the wet elongation percentage measurements, the tension corresponding to 100% elongation was measured, and the wet 100% modulus was calculated by dividing that value by the sectional area of the test specimen.

<Oxyethylene Group Content>

The content was calculated based on ¹H—NMR data.

<Isocyanato Group Content>

The polymer was dissolved in a toluene solution of dibutylamine with a concentration of 0.5 M and, after 30 minutes of stirring, titration was carried out with ½ N hydrochloric acid in methanol. The thus-found number of moles of NCO groups per unit weight was multiplied by 42.

<Allophanate/biuret Content Expressed in Terms of Isocyanato Group Content>

The sample (100 mg) was added to 5 ml of an anhydrous dimethylformamide solution containing 0.1% by weight of di-n-butylamine and 0.1% by weight of naphthalene and, after 40 minutes of reaction at 70° C., 10 μl of acetic anhydride was added. After the lapse of 10 minutes, the reaction mixture was analyzed by gas chromatography, and the peak area ratio (SA) between di-n-butylacetamide and naphthalene was determined. In a blank run, 100 mg of the sample was added to 5 ml of an anhydrous dimethylformamide solution containing 0.1% by weight of di-n-butylamine and 0.1% by weight of naphthalene and, after 40 minutes of reaction at 25° C., 10 pl of acetic anhydride was added. After the lapse of 10 minutes, the reaction mixture was analyzed by gas chromatography, and the peak area ratio (SB) between di-n-butylacetamide and naphthalene was determined. The content in question was calculated as follows: [(SB—SA)/SB]×0.613.

<Alkali Metal and Alkaline Earth Metal Content>

The sample (10 g) was heated and incinerated on a platinum dish, the ash was dissolved in 10 g of water, the solution was subjected to ion chromatography, and the content in question was determined.

<Mn>

The Mn was determined by GPC using polyethylene glycol species as standard substances.

<Content of Isocyanato Group-containing Polymer Molecules Having a Molecular Weight of 500 to 500,000>

The content was calculated based on the molecular weight distribution curve obtained by GPC, using a refractive index detector, of a solution of the polymer in a dimethylformamide solution of dibutylamine (standard substances: polyethylene glycol species) and the molecular weight distribution curve for urethane prepolymer molecules having a Mn of not lower than 500 but not higher than 500,000 as obtained by GPC, using an ultraviolet detector, of a solution of the polymer in a dimethylformamide solution of 4-aminopyridine (standard substances: N-methylaminopyridine-ethylene oxide adducts).

<Number of Tertiary Amino Group and/or Quaternary Ammonio Group Contented>

The number was calculated based on ¹H-NMR data.

<Content of Amine (C)>

The polymer was dispersed in methanol, the dispersion was stirred at room temperature for 1 hour, the solution fraction was analyzed by gas chromatography, and the content was calculated.

<Adhesive Appearance>

1 g of the polymer was placed in a 10-mL screw tube, and the fluidity and homogeneity at 25° C. were evaluated according to the following criteria:
Excellent: Fluid and homogeneous;
Fair: Rather poorly fluid but homogeneous;
Poor: Poorly fluid and lumps are observed here and there.
   <Applicability>

Two collagen films (1×5 cm) were immersed in physiological saline for 24 hours, the surface water was then wiped off, and about 0.1 mL of the polymer was applied to the terminal 1×1 cm area of one of the films using a spatula made of polytetrafluoroethylene. The applicability on that occasion was evaluated according to the following criteria:
Excellent: Readily spreadable, hence good workability;
Poor: Hardly spreadable, hence poor workability.
   <Initial Adhesive Strength>

Two collagen films (1×5 cm) were immersed in physiological saline for 24 hours, the surface water was then wiped off, and about 0.1 mL of the polymer was applied to the terminal 1×1 cm area of one of the films using a spatula made of polytetrafluoroethylene, and the terminal 1×1 cm area of the other film was put on top of the coated area. for adhering to give a test specimen. A weight of 100 g was placed on the adhered area (1×1 cm) of this test specimen, the whole was allowed to stand in an atmosphere of 37° C. and 98% humidity for 5 minutes, the weight was then removed, and the tensile strength was measured in an atmosphere of 37° C. and 98% humidity according to JIS K 6850-1999. The load at break was recorded as the initial adhesive strength. The tensile testing machine used was a Shimadzu Corp's model AGS-500B autograph, and the rate of pulling was 300 mm/min.

<Water-resistant Adhesive Strength>

Two collagen films (1×5 cm) were immersed in physiological saline for 24 hours, the surface water was then wiped off, and about 0.1 mL of the polymer was applied to the terminal 1×1 cm area of one of the films using a spatula made of polytetrafluoroethylene, and the terminal 1×1 cm area of the other film was put on top of the coated area for adhering to give a test specimen. A weight of 100 g was placed on the adhered area (1×1 cm) of this test specimen, and the whole was allowed to stand at 37° C. for 30 minutes. The weight was then removed, and the test specimen, after 48 hours of immersion in physiological saline, was measured for tensile strength in an atmosphere of 37° C. and 98% humidity according to JIS K 6850-1999. The load at break was recorded as the adhesive strength. The tensile testing machine used was a Shimadzu Corp's model AGS-500B autograph, and the rate of pulling was 300 mm/min.

<Repeated Bending Adhesive Strength>

Two collagen films (1×5 cm) were immersed in physiological saline for 24 hours, the surface water was then wiped off, and about 0.1 mL of the polymer was applied to the terminal 1×1 cm area of one of the films using a spatula made of polytetrafluoroethylene, and the terminal 1×1 cm area of the other film was put on top of the coated area for adhering to give a test specimen. A weight of 100 g was placed on the adhered area (1×1 cm) of this test specimen, and the whole was allowed to stand at 37° C. for 30 minutes. The weight was then removed, the specimen was mounted, with both ends of the adhered area fixed, on a bending testing machine placed in an atmosphere of 37° C. and 95% relative humidity in such a manner that the middle of the adhered area (1×1 cm) might be bent, and bending was repeated for one week under the following conditions: bending frequency: once/minute, bending angle: 90/2700. The tensile strength of the thus repeatedly bent test specimen was measured in an atmosphere of 37° C. and 98% humidity according to JIS K 6850-1999. The load at break was recorded as the adhesive strength. The tensile testing machine used was Shimadzu Corp's model AGS-500B autograph, and the rate of pulling was 300 mm/min.

TABLE 1

| | Example | | | | | | |
|---|---|---|---|---|---|---|---|
| | 1 | 2 | 3 | 4 | 5 | 6 | 7 |
| Polymer | UP1 | UP2 | UP3 | UP4 | UP5 | UP6 | UP7 |
| Viscosity(Pa · s) | 11.0 | 10.2 | 90.1 | 10.5 | 12.1 | 14.4 | 11.4 |
| Saturated water absorption | 0.60 | 0.65 | 0.45 | 0.50 | 0.60 | 0.60 | 0.50 |
| (g/g) | | | | | | | |
| Initial water absorption rate | 0.05 | 0.06 | 0.03 | 0.06 | 0.05 | 0.05 | 0.07 |
| (g/g · min) | | | | | | | |
| Wet elongation percentage | 600 | 800 | 300 | 400 | 600 | 600 | 400 |
| (%) | | | | | | | |
| Wet 100% modulus (MPa) | 0.55 | 0.60 | 0.80 | 0.35 | 0.65 | 0.60 | 0.30 |
| Oxyethylene group content | 65 | 55 | 45 | 65 | 66 | 64 | 53 |
| (wt %) | | | | | | | |
| NCO content*¹ (wt %) | 3.4 | 4.7 | 3.7 | 3.5 | 3.1 | 1.3 | 4.6 |
| Metal content*³ (mmol/kg) | 0.016 | 0.020 | 0.028 | 0.020 | 0.020 | 0.019 | 0.019 |
| AB content*² (wt %) | 0.06 | 0.07 | 0.15 | 0.06 | 0.06 | 0.06 | 0.07 |
| Polymer content*⁴ (wt %) | 98.0 | 98.5 | 98.5 | 97.0 | 99.5 | 98.5 | 97.2 |
| Amino content*⁶ (groups/g) | <0.01 | <0.01 | <0.01 | <0.01 | <0.01 | <0.01 | <0.01 |
| Amine content (wt %) | <0.1 | <0.1 | <0.1 | <0.1 | <0.1 | <0.1 | <0.1 |
| Adhesive appearance | Excellent | Excellent | Excellent | Excellent | Excellent | Excellent | Excellent |
| Applicability | Excellent | Excellent | Fair | Excellent | Excellent | Excellent | Excellent |
| Initial adhesive strength | 1.1 | 1.0 | 0.6 | 0.4 | 1.0 | 1.1 | 0.4 |
| Water-resistant adhesive | 0.9 | 1.5 | 0.8 | 0.6 | 1.5 | 1.4 | 0.6 |
| strength | | | | | | | |
| Repeated bending adhesive | 0.9 | 0.8 | 0.5 | 0.2 | 1.0 | 1.1 | 0.3 |
| strength | | | | | | | |
| | Example | | | | | | |
| | 8 | 9 | 10 | 11 | 12 | 13 | 14 |
| Polymer | UP8 | UP9 | UP10 | UP11 | UP12 | UP13 | UP14 |
| Viscosity(Pa · s) | 17.0 | 15.1 | 16.1 | 14.7 | 15.3 | 8.4 | 8.3 |
| Saturated water absorption | 0.60 | 0.60 | 0.60 | 0.65 | 0.70 | 0.50 | 0.60 |
| (g/g) | | | | | | | |
| Initial water absorption rate | 0.05 | 0.05 | 0.05 | 0.06 | 0.05 | 0.04 | 0.06 |
| (g/g · min) | | | | | | | |
| Wet elongation percentage | 600 | 800 | 700 | 800 | 800 | 900 | 700 |
| (%) | | | | | | | |
| Wet 100% modulus (MPa) | 0.55 | 0.55 | 0.60 | 0.65 | 0.65 | 0.35 | 0.45 |
| Oxyethylene group content | 52 | 65 | 62 | 65 | 65 | 65 | 65 |
| (wt %) | | | | | | | |
| NCO content*¹ (wt %) | 4.2 | 3.5 | 3.3 | 3.4 | 3.5 | 3.5 | 3.5 |
| Metal content*³ (mmol/kg) | 0.019 | 0.020 | 0.019 | 0.020 | 0.020 | 0.020 | 0.020 |
| AB content*² (wt %) | 0.07 | 0.06 | 0.06 | 0.07 | 0.07 | 0.06 | 0.06 |
| Polymer content*⁴ (wt %) | 98.5 | 98.5 | 98.5 | 98.5 | 98.5 | 97.0 | 97.0 |
| Amino content*⁶ (groups/g) | <0.01 | 2.4 × 10₂₀ | 2.3 × 10₂₀ | 2.5 × 10₂₀ | 1.2 × 10₂₀ | <0.01 | <0.01 |
| Amine content (wt %) | <0.1 | <0.1 | <0.1 | <0.1 | <0.1 | <0.1 | 0.6 |
| Adhesive appearance | Excellent | Excellent | Excellent | Excellent | Excellent | Excellent | Excellent |
| Applicability | Excellent | Excellent | Excellent | Excellent | Excellent | Excellent | Excellent |
| Initial adhesive strength | 1.0 | 1.2 | 1.1 | 1.1 | 0.8 | 0.3 | 1.1 |
| Water-resistant adhesive | 1.4 | 1.5 | 0.9 | 1.2 | 1.2 | 0.6 | 0.9 |
| strength | | | | | | | |
| Repeated bending adhesive | 1.2 | 1.0 | 0.9 | 0.8 | 0.6 | 0.2 | 0.9 |
| strength | | | | | | | |

TABLE 2

| | Example | | | | | | |
|---|---|---|---|---|---|---|---|
| | 15 | 16 | 17 | 18 | 19 | 20 | 21 |
| Polymer | UP15 | UP16 | UP17 | UP18 | UP19 | UP20 | UP21 |
| Viscosity (Pa · s) | 7.0 | 8.3 | 7.4 | 9.3 | 9.5 | 11.1 | 10.5 |
| Saturated water absorption | 0.60 | 0.60 | 0.60 | 0.50 | 0.60 | 0.50 | 0.55 |
| (g/g) | | | | | | | |
| Initial water absorption rate | 0.06 | 0.06 | 0.06 | 0.04 | 0.06 | 0.05 | 0.05 |
| (g/g · min) | | | | | | | |
| Wet elongation percentage | 700 | 700 | 800 | 900 | 700 | 800 | 600 |
| (%) | | | | | | | |
| Wet 100% modulus (MPa) | 0.45 | 0.50 | 0.45 | 0.35 | 0.45 | 0.55 | 0.55 |
| Oxyethylene group content | 65 | 65 | 65 | 63 | 63 | 65 | 50 |
| (wt %) | | | | | | | |
| NCO content*¹ (wt %) | 3.5 | 3.5 | 3.5 | 3.3 | 3.3 | 3.4 | 4.2 |
| Metal content*³ (mmol/kg) | 0.019 | 0.020 | 0.019 | 0.019 | 0.019 | 0.016 | 0.014 |
| AB content*² (wt %) | 0.06 | 0.06 | 0.06 | 0.05 | 0.05 | 0.06 | 0.05 |
| Polymer content*⁴ (wt %) | 97.0 | 97.0 | 97.0 | 97.0 | 97.0 | 98.0 | 98.0 |
| Amino content*⁵ (groups/g) | <0.01 | <0.01 | <0.01 | <0.01 | <0.01 | <0.01 | <0.01 |
| Amine content (wt %) | 4.8 | 0.6 | 2.0 | <0.1 | <0.1 | <0.01 | <0.01 |
| Adhesive appearance | Excellent | Excellent | Excellent | Excellent | Excellent | Excellent | Excellent |
| Applicability | Excellent | Excellent | Excellent | Excellent | Excellent | Excellent | Excellent |
| Initial adhesive strength | 1.2 | 1.1 | 0.8 | 0.3 | 1.2 | 1.5 | 1.4 |
| Water-resistent adhesive | 1.0 | 0.9 | 0.8 | 0.6 | 1.2 | 1.4 | 1.3 |
| strength | | | | | | | |
| Repeated bending adhesive | 1.0 | 0.8 | 0.6 | 0.2 | 0.9 | 1.3 | 1.0 |
| strength | | | | | | | |

| | Example | | Comparative Example | | | |
|---|---|---|---|---|---|---|
| | 22 | 23 | 1 | 2 | 3 | 4 |
| Polymer | NUP1 | NUP2 | HUP1 | HUP2 | HUP3 | HUP4 |
| Viscosity (Pa · s) | 6.4 | 3.1 | 2510 | 2840 | 5.3 | 2.7 |
| Saturated water absorption | 0.60 | 0.55 | 0.40 | 0.40 | 0.15 | 0.10 |
| (g/g) | | | | | | |
| Initial water absorption rate | 0.05 | 0.05 | 0.02 | 0.02 | 0.02 | 0.01 |
| (g/g · min) | | | | | | |
| Wet elongation percentage | 700 | 600 | 200 | 300 | 150 | 100 |
| (%) | | | | | | |
| Wet 100% modulus (MPa) | 0.60 | 0.55 | 0.80 | 0.75 | 0.70 | 0.80 |
| Oxyethylene group content | 78 | 73 | 65 | 45 | 8 | <0.1 |
| (wt %) | | | | | | |
| NCO content*¹ (wt %) | 2.1 | 3.2 | 2.8 | 3.1 | 8.0 | 8.2 |
| Metal content*³ (mmol/kg) | 0.020 | 0.020 | 0.065 | 0.050 | 0.006 | 0.006 |
| AB content*² (wt %) | <0.01 | <0.01 | 0.64 | 0.70 | 0.12 | 0.14 |
| Polymer content*⁴ (wt %) | 99.5 | 99.5 | 98.0 | 98.0 | 99.0 | 99.0 |
| Amino content*⁵ (groups/g) | <0.01 | <0.01 | <0.01 | <0.01 | <0.01 | <0.01 |
| Amine content (wt %) | <0.01 | <0.01 | <0.1 | <0.01 | <0.01 | <0.01 |
| Adhesive appearance | Excellent | Excellent | Poor | Poor | Excellent | Excellent |
| Applicability | Excellent | Excellent | Poor | Poor | Fair | Fair |
| Initial adhesive strength | 1.2 | 1.2 | 0.2 | 0.2 | <0.1 | <0.1 |
| Water-resistent adhesive | 1.0 | 1.1 | 0.3 | 0.5 | 0.2 | 0.1 |
| strength | | | | | | |
| Repeated bending adhesive | 1.4 | 1.2 | <0.1 | <0.1 | <0.1 | <0.1 |
| strength | | | | | | |

*¹Isocyanato group content
*²Allophanate/biuret content expressed in terms of isocyanato group content
*³Alkali metal and alkaline earth metal content
*⁴Content of molecules of Mn (500 to 500,000)
*⁵Number of tertiary amino groups and/or quaternary ammonio groups contained.

The following evaluation test was carried out using (UP1) to (UP3), HUP1 and HUP2. The results are shown in Table 3.

<In Vivo Adhesion Test>

The carotid artery (outside diameter about 4 mm) of an adult goat was temporarily ligated over a length of about 5 mm by means of two vascular clamps and the blood vessel portion between them was given an incision about 3 mm in length in the longitudinal direction of the vessel, and 0.1 mL of the polymer of the invention was applied onto the incision using a spatula made of polytetrafluoroethylene. Five minutes later, the blood flow was resumed by removing the two vascular clamps and, further 5 minutes later, the occurrence or nonoccurrence of bleeding was judged by visual observation to evaluate the adhesive properties of the polymer.

TABLE 3

| | Polymer | Evaluation result |
|---|---|---|
| Example1 | U P 1 | No bleeding |
| Example2 | U P 2 | No bleeding |
| Example3 | U P 3 | No bleeding |
| Comparative | H U P 1 | Bleeding from around |
| Example1 | | |
| Comparative | H U P 2 | Bleeding from around |
| Example2 | | |

### Industrial Aplicability

The polymer of the invention is very good in appearance, water-resistant adhesive strength, repeated bending adhesive strength, applicability and initial adhesive strength. Therefore, it is suitable for use in adhering vital tissues, and the like, and thus is best suited for use as a medical adhesive in adhering vital tissues, such as liver, kidney, spleen, pancreas, heart, lung, blood vessels (artery, vein, capillary vessel, etc.), trachea, bronchus, digestive tracts (esophagus, stomach, duodenum, small intestine, large intestine, rectum, etc.) and nerves, in stopping bleeding, in preventing contents, enzyme, digestive juices or the like fluid from leaking from digestive organs, temporary fixation prior to suture, reinforcing joints (sites of suture and sites of anastomosis) etc., and the like. Furthermore, it exhibits high reliability and high performance characteristics in joining wound faces, incised wound faces and the like, and in adhering treatment in dental surgery as well.

1. An isocyanato group-containing polymer capable of forming a cured film and useful as a medical adhesive,
which has a viscosity at 37° C. of 0.5 to 2,000 Pa·s, shows a saturated water absorption of 0.2 to 5 ml/g, and has the alkali metal and alkaline earth metal content of 0 (zero) or lower than 0.04 mmol/kg based on the weight of the polymer.

2. The polymer according to claim 1,
which shows an initial water absorption rate of 0.01 to 0.5 ml/g·min, the wet elongation percentage of the cured film of 100 to 1,500% and the wet 100% modulus of the cured film of 0.01 to 10 MPa, and contains oxyethylene groups and, in which the oxyethylene group content is 30 to 100% by weight based on the weight of the polymer.

3. (Canceled)

4. (Canceled)

5. (Canceled)

6. (Canceled)

7. The polymer according to claim 1,
wherein the isocyanato group content is 0.1 to 20% by weight based on the weight of the polymer.

8. The polymer according to claim 1,
wherein the allophanate/biuret content expressed as the corresponding isocyanato group content is 0 or lower than 0.6% by weight based on the weight of the polymer.

9. (Canceled)

10. The polymer according to claim 1,
wherein the content of isocyanato group-containing polymer molecules having a number average molecular weight of 500 to 500,000 is 98 to 100% by weight based on the weight of the polymer.

11. The polymer according to claim 1,
which is a tertiary amino group- and/or quaternary ammonio group-containing one and,
in which the number of the tertiary amino groups and quaternary ammonio groups contained therein is 1×10¹⁷ to 1×10²³ groups/g based on the weight of the polymer

12. The polymer according to claim 1, which contains an active hydrogen-free and isocyanato group-free amine (C).

13. The polymer according to claim 1, which comprises an isocyanato group-containing polymer derived from a polyisocyanate (A) and an active hydrogen-containing polymer (B) selected from the group consisting of hydroxyl group-containing polyethers (B1), mercapto group-containing polyethers (B2), primary and/or secondary amino group-containing polyethers (B3), carboxyl group-containing polyethers (B4), hydroxyl group-containing polyesters (B5), mercapto group-containing poly(thio)esters (B6), primary and/or secondary amino group-containing polyesters (B7), carboxyl group-containing polyesters (B8), hydroxyl group-containing polyamides (B9), mercapto group-containing polyamides (B10), primary and/or secondary amino group-containing polyamides (B11) and carboxyl group-containing polyamides (B12).

14. The polymer according to claim 13,
wherein the polyisocyanate (A) comprises a fluorine-containing aliphatic polyisocyanate and/or a fluorine-containing alicyclic polyisocyanate.

15. The polymer according to claim 13,
wherein the alkali metal and/or alkaline earth metal content in the active hydrogen-containing polymer (B) is 0 (zero) or lower than 0.07 mmol/kg based on the weight of (B).

16. The polymer according to any one of claims 13,
wherein the active hydrogen-containing polymer (B) is an ethylene oxide-propylene oxide random copolymer.

17. An isocyanato group-containing polymer polymer capable of forming a cured film and useful as a medical adhesive,
which has a viscosity at 37° C. of 0.5 to 2,000 Pa·s, shows a saturated water absorption of 0.2 to 5 ml/g, and has a structure resulting from conversion of at least one functional group in an active hydrogen-containing polymer (B) selected from the group consisting of polyethers, polyesters and polyamides to an isocyanato group.

18. The polymer according to claim 1,
which is intended for use in preventing fluid leakage from a vital tissue and/or adhering a vital tissue.

19. The polymer according to claim 18,
wherein the vital tissue comprises at least one tissue selected from the group consisting of liver, kidney, spleen, pancreas, heart, lung, blood vessels, trachea, bronchus, digestive tracts and nerves.

20. A process for producing the polymer according to claim 1,
which comprises converting an active hydrogen-containing polymer (B) having an alkali metal and/or alkaline earth metal content of 0 (zero) or lower than 0.07 mmol/kg to an isocyanato group-containing polymer.

21. An isocyanato group-containing polymer capable of forming a cured film and useful as a medical adhesive,
wherein the content of isocyanato group-containing polymer molecules having a number average molecular weight of 500 to 500,000 is 98 to 100% by weight based on the weight of the polymer.

22. An isocyanato group-containing polymer capable of forming a cured film and useful as a medical adhesive,
which is obtainable by using a tertiary amino group- and/or quaternary ammonio group-containing polyisocyanate, and is a tertiary amino group- and/or quaternary ammonio group-containing polymer and,
in which the number of the tertiary amino groups and quaternary ammonio groups contained therein is 1×10¹⁷ to 1×10²³ groups/g based on the weight of the polymer.

23. An isocyanato group-containing polymer capable of forming a cured film and useful as a medical adhesive,
which comprises an isocyanato group-containing polymer derived from a polyisocyanate (A) and an active hydrogen-containing polymer (B) selected from the group consisting of mercapto group-containing polyethers (B2), primary and/or secondary amino group-containing polyethers (B3), carboxyl group-containing polyethers (B4), hydroxyl group-containing polyesters (B5), mercapto group-containing poly(thio)esters (B6), primary and/or secondary amino group-containing polyesters (B7), carboxyl group-containing polyesters (B8), hydroxyl group-containing polyamides (B9), mercapto group-containing polyamides (B10), primary and/or secondary amino group-containing polyamides (B11) and carboxyl group-containing polyamides (B12).

24. The polymer according to claim 17,
which is intended for use in preventing fluid leakage from a vital tissue and/or adhering a vital tissue.
